(19) United States
(12) Patent Application Publication
(10) Pub. No.: US 2021/0276226 A1
(43) Pub. Date: Sep. 9, 2021

(54) METHODS AND SYSTEMS FOR DYNAMICALLY PROCESSING WASTE

(71) Applicant: PETRA IP PTY LTD, Baulkham Hills NSW (AU)

(72) Inventors: Peter John Campbell, Petersham (AU); Peter Kay, Earlwood (AU); David Cassidy, Wahroonga (AU); Peter Williams, Belmont, CA (US)

(73) Assignee: PETRA IP PTY LTD, Baulkham Hills NSW (AU)

(21) Appl. No.: 16/813,109

(22) Filed: Mar. 9, 2020

(51) Int. Cl. B29B 17/02; G06Q 10/00; G06Q 50/04; G05B 13/02; B01F 15/00; B01F 3/20; B03C 1/23; B29B 17/04; B02C 23/14; B07B 15/00; B02C 21/00

(52) U.S. Cl. CPC B29B 17/02; B29B 2017/0262; G06Q 50/04; G05B 13/0265; B01F 15/00253; B01F 3/2071; B01F 3/2092; B03C 1/23; B29B 17/04; B02C 23/14; B07B 15/00; B02C 21/00; B01F 2215/0049; B03C 2201/20; B29B 2017/0272; B29B 2017/0224; B29B 2017/0203; G06Q 10/30

(57) ABSTRACT

A method for producing a thermal product with a consistent and designable thermal property is disclosed. The method comprises producing from a municipal waste a cellulose-based material stockpile and a plastic-based material stockpile; automatically measuring at least one physical property of the cellulose-based material stockpile and at least one physical property of the plastic-based material stockpile; based on the measurements of the at least one physical property the cellulose-based material stockpile and the measurements of the at least one physical property of the plastic-based material stockpile, automatically controlling mixing the cellulose-based material stockpile and the plastic-based material stockpile to form a mixture by adjusting a ratio of the cellulose-based material stockpile to the plastic-based material stockpile; and automatically heating and compressing the mixture to form the thermal product.

### CROSS-REFERENCES TO RELATED APPLICATIONS

N/A

### BACKGROUND

The sourcing, sorting and management of waste is a disparate end to end system. Although burning of household waste has been undertaken for many years and systems such as Kernerator, have provided means for houses, factories and other buildings to manage waste, the useful production of energy with minimal negative environmental impact has become a major challenge, particularly with the rise in use of plastics.

Raw municipal waste constituent attributes may, e.g., be approximately those illustrated in Table 1.

TABLE 1
Typical constituents of raw waste

| Component of | % by Weight (wet basis) | | | | | | | | LHV |
|---|---|---|---|---|---|---|---|---|---|
| Waste Stream | Moisture | Carbon | Hydrogen | Oxygen | Nitrogen | Sulphur | Chlorine | Ash | (Mj/kg) |
| Paper | 17.72 | 32.28 | 4.70 | 28.44 | 0.38 | 0.01 | 0.03 | 16.17 | 12.06 |
| Misc. | 60.00 | 14.57 | 2.10 | 11.01 | 0.17 | 0.01 | 0.15 | 12.00 | 4.24 |
| Combustibles | | | | | | | | | |
| Plastics | 5.94 | 70.08 | 9.38 | 5.15 | 0.71 | 0.14 | 1.22 | 7.37 | 32.62 |
| Food | 65.08 | 14.43 | 2.00 | 11.10 | 0.80 | 0.02 | 0.36 | 6.21 | 4.08 |
| Incombustibles | 30.00 | 0.00 | 0.00 | 0.00 | 0.00 | 0.00 | 0.00 | 70.00 | −2.21 |
| Fabric/Rubber/ | 8.07 | 47.56 | 5.98 | 20.03 | 1.48 | 0.09 | 4.13 | 12.47 | 19.79 |
| leather | | | | | | | | | |
| Wood | 14.11 | 39.53 | 5.18 | 30.86 | 0.59 | 0.02 | 0.24 | 12.47 | 15.02 |
| Average | 30.29 | 32.60 | 4.53 | 15.58 | 0.43 | 0.04 | 0.51 | 9.47 | 12.99 |

As shown in Table 1, paper, plastics, fabric/rubber/leather and wood indicates the lower heating value LHVs that can be targeted in the waste stream for re-purposing. LHV takes into account moisture, which must be evaporated during the combustion process, reducing the thermal output. As illustrated by Table 1, some constituents of raw waste are generally not capable of generating thermal output in a meaningful way.

Paper and cardboard as wood derivatives have thermal energy release potential. Plastics are made of hydrocarbons and are commonly used in domestic, commercial and industrial settings, and are typically more energy dense than coal. Traditional methods of disposal of plastics, such as unconstrained burning and/or landfill have negative environmental impacts, including production of known carcinogenic substances such as Dioxin. Further, emissions can be excessive with end use burn without scrubbing, in particular for PVC plastics.

There are a large number of waste to energy (WTE) plants globally. On average, at least about 1.82 metric tons of municipal raw waste are needed to produce 1 MegaWatt Hour (MWh) of electricity. The municipal raw waste could have variable waste types in it (typically described in Table 1, which approximates to a thermal capability of raw waste to be 748 kcal/kg. Until recently, after removing recyclables, the remaining plastics and paper waste was bundled into what is call a Solid Recovered Fuels (SRF) bail, sometimes also called Refuse Derived Fuels. Some SRF bails are not processed or processed in poor environmental conditions. Currently, SRF waste bails are sometimes used in production of cement, e.g., in combination with coal in cement kilns. The bails frequently encounter issues where there is a bulk load of plastics, since the bulk does not burn out and may cause clogs from molded plastic, as well as generating unwanted emissions. Some countries also burn SRF bails to produce energy (e.g., heat water to produce steam for heating systems and/or turn turbines for electricity).

There are many issues and challenges relating to using untreated waste/SRF bails to produce energy. For example, some of the challenges are discussed as follow:

1) If untreated, the waste/SRF bails may not be efficiently processed to reach their thermal capabilities.

2) Burning the raw untreated waste/SRF bails can lead to unpredictable emissions, particularly when the waste/SRF bails are not pre-processed. Proper processing to filter out unwanted waste materials is required so that the waste/SRF bails only include waste material types with known emissions. For example, PVC plastic with high dioxin emission may be removed before the waste/SRF bails including PET plastics can be burnt.

3) In countries (e.g., France) where WTE plants have been used for many years, there is a consumer backlash to its waste use for energy. Similarly, in Australia, plants were planned for burning waste, and the consumer backlash halted such initiatives.

4) Even though the emissions are far better than most consumers appreciate, the idea of burning waste currently has a poor consumer perception.

Needed in the art are methods and systems for dynamically processing waste.

### SUMMARY

In one aspect, the present disclosure relates to a method for producing a thermal product with a consistent and designable thermal property.

According to one non-limiting aspect of the present disclosure, an example method includes: producing from a municipal waste a cellulose-based material stockpile and a plastic-based material stockpile; automatically measuring at least one physical property of the cellulose-based material stockpile and at least one physical property of the plastic-based material stockpile; based on the measurements of the at least one physical property the cellulose-based material stockpile and the measurements of the at least one physical property of the plastic-based material stockpile, automatically controlling mixing the cellulose-based material stockpile and the plastic-based material stockpile to form a mixture by adjusting a ratio of the cellulose-based material stockpile to the plastic-based material stockpile; and automatically heating and compressing the mixture to form the thermal product.

In one embodiment, the at least one physical property comprises one or more of density, purity, weight, thermal capability (measured in kcal/kg), combustion efficiency, direct and ambient heat at varying pressure levels (similar to pressure levels in end use kilns), wetness and average sizes of the cellulose-based material pieces or the paper-based material pieces.

In one embodiment, the method further comprises utilizing a machine learning model to heuristically optimize the thermal property of the thermal product.

In an embodiment, the present disclosure relates to a method for isolating at least one recycle product from a municipal waste and producing a thermal product from the municipal waste.

In one embodiment, the method comprises pre-sorting the municipal waste into at least a first waste comprising a majority of plastic-based material and a second waste comprising a majority of at least one cellulose-based material selected from the group consisting of paper, cardboard, wood, textile and carpet.

In one embodiment, the method further comprises separating the at least one recycle product from the first waste and producing a first stockpile from the first waste, which specifically comprises: shredding, by using a first shredder comprising a magnetic belt, the first waste and separating ferrous-based recycle products from the first waste either before or after the shredding to form a first intermediate waste; sieving, by using a first screening or sieving device, the first intermediate waste to separate sand and/or soil-based recycle products to form a second intermediate waste; separating, by using a first air classifier, heavy recycle products from the second intermediate waste to form a third intermediate waste; and extracting, by using a first eddy current system, non-ferrous metals such as aluminum from the third intermediate waste to form the first stockpile.

In one embodiment, the method further comprises separating the at least one recycle product from the second waste and producing a second stockpile to form the second waste, which specifically comprises shredding, by using a second shredder comprising a magnetic belt, the second waste and separating ferrous-based recycle products from the second waste either before or after the shredding to form a fourth intermediate waste; sieving, by using a second screening or sieving device comprising a heating device, the fourth intermediate waste to separate sand and/or soil-based recycle products to form a fifth intermediate waste; separating, by using a second air classifier, heavy recycle products from the fifth intermediate waste to form a sixth intermediate waste; and extracting, by using a second eddy current system, non-ferrous metals such as aluminum from the sixth intermediate waste to form the second stockpile.

In one embodiment, the method further comprises processing the first stockpile and the second stockpile to produce the thermal product, which specifically comprises: controlled mixing, by using a mixer, the first stockpile and the second stockpile proportionally to form a first mixture; shredding, by using a hammer mill or a shredder capable of shredding a material into a sufficiently small size, e.g., 1 cm approx., the first mixture into pieces with a pre-determined size to form a second mixture; measuring, by using an X-ray Fluorescence (XRF) system, at least one physical property of the second mixture, identifying and removing additional recycle products to form a third mixture; and heating and compressing, by using a thermal-product-forming machine, the third mixture to form the thermal product.

In one embodiment, the first stockpile is a cellulose-based material stockpile and the second stockpile is a plastic-based material stockpile.

In one embodiment, the method comprises automatically controlled mixing the cellulose-based material stockpile and the plastic-based material stockpile to form a mixture by adjusting a ratio of the cellulose-based material stockpile to the plastic-based material stockpile on the basis of the measurement of the at least one physical property.

In one embodiment, the method further comprises utilizing a machine learning model to optimize thermal property of the thermal product.

In one embodiment, the at least one physical property further comprises one or more of density, purity, wetness and average sizes of the cellulose-based material pieces or the plastic-based material pieces.

In one embodiment, the at least one recycled product comprise at least one material selected from the group consisting of glass, aluminum, soil, sand, rock, brick, ferrous metal, non-ferrous metal and non-aluminum metal.

In one embodiment, the method further comprises controlling a mixture ratio of the first stockpile to the second stockpile to produce the thermal product with a consistent and designable thermal property.

In one embodiment, the method further comprises controlling a mixture ratio of the first stockpile to the second stockpile to produce the thermal product with a thermal property in the range of about 1,000 kcal/kg to about 10,000 kcal/kg, or preferably 2,000 kcal/kg to about 9,000 kcal/kg, and more preferably about 3,000 kcal/kg to about 8,000 kcal/kg.

In one embodiment, the thermal product is a briquette. In some embodiments, the briquette is selected from the group consisting of a brown Petra with a thermal property of about 3,000 kcal/kg to about 4,000 kcal/kg, a black Petra with a thermal property of about 4,000 kcal/kg to about 5,500 kcal/kg, and a coking Petra with a thermal property of about 5,500 kcal/kg to about 7,500 kcal/kg.

In one embodiment, the thermal product is a feedstock, with thermal properties that can be configured to range from 3000 kcal/kg to 7,500 kcal/kg.

In one embodiment, during the pre-sorting step, bulk concrete and other low-thermal-property materials are removed from the municipal waste.

In one embodiment, during the first separating step (i.e., for producing a first stockpile), steels or other magnetic metals are removed from the first waste.

In one embodiment, the plastic-based material in the first intermediate waste is shredded into plastic pieces about 40 mm to about 60 mm in diameter.

In one embodiment, during the first separating step (i.e., for producing a first stockpile), sand and/or soil are removed from the first intermediate waste and are collected as the at least one recycle product.

In one embodiment, during the first separating step (i.e., for producing a first stockpile), heavy materials such as rocks, bricks and heavy metals are removed from the second intermediate waste and are collected as the at least one recycle product.

In one embodiment, during the first separating step (i.e., for producing a first stockpile), non-ferrous metals such as aluminum are removed from the third intermediate waste and are collected as the at least one recycle product.

In one embodiment, during the second separating step (i.e., for producing a second stockpile), steels or other metals with magnetic properties are removed from the second waste.

In one embodiment, the at least one cellulose-based material in the fourth intermediate waste is shredded into cellulose-based material pieces about 40 mm to about 60 mm in diameter.

In one embodiment, the at least one cellulose-based material in the fourth intermediate waste is shredded into cellulose-based material pieces about 60 mm in diameter.

In one embodiment, during the second separating step (i.e., for producing a second stockpile), sand and/or soil are removed from the fourth intermediate waste and are collected as the at least one recycle product.

In one embodiment, during the second separating step (i.e., for producing a second stockpile), heavy materials such as rocks, bricks and heavy metals are removed from the fifth intermediate waste and are collected as the at least one recycle product.

In one embodiment, during the second separating step (i.e., for producing a second stockpile), non-ferrous metals such as aluminum are removed from the sixth intermediate waste and are collected as the at least one recycle product.

In one embodiment, during the processing step (i.e., to produce the thermal product), the ratio of the first stockpile to the second stockpile is in the range of 1:100 to 100:1.

In one embodiment, during the processing step (i.e., to produce the thermal product), the ratio of the first stockpile to the second stockpile is in the range of 1:50 to 50:1.

In one embodiment, during the processing step (i.e., to produce the thermal product), the ratio of the first stockpile to the second stockpile is in the range of 1:10 to 10:1.

In one embodiment, during the processing step (i.e., to produce the thermal product), the plastic pieces and the cellulose-based material pieces are further shredded into mixture pieces about 1 mm to about 10 mm in diameter. The size of these pieces is determined, in part by the final outcome, either as feedstock or briquettes, and the intended application of both, in terms of thermal characteristics.

In one embodiment, during the processing step (i.e., to produce the thermal product), the method further comprises identifying, by using XRF system, additional recycle products; and removing the additional recycle products from the second mixture and collecting them as the at least one recycle product.

In one embodiment, during the processing step (i.e., to produce the thermal product), the method further comprises identifying, by using XRF system, contaminants such as PVC; and removing the contaminants from the second mixture.

In one embodiment, during the processing step (i.e., to produce the thermal product), the method further comprises controlling the thermal property of the thermal product by varying a ratio of the first stockpile to the second stockpile.

In one embodiment, the method is automatically controlled through a controller.

In one embodiment, the controller controls the method through the XRF system, e.g., assessing thermal capability of the shredded waste mixtures, their moisture and/or whether or not the remaining materials of the mixtures will result in the desired minimization of environmental emissions. In one embodiment, the XRF system may be a primary means of sourcing the above information to feed into a data pool of the system, which the controller may use to make heuristic decisions to control the end to end process.

In one embodiment, the method further comprises a step of quality control, wherein a controller takes inputs from the XRF system and wherein if necessary, the controller sends instructions to related machines to take steps to increase quality of the thermal product.

In another aspect, the present disclosure relates to a system having a plurality of components capable of performing the above method for processing a municipal waste (also referred to as MSW), commercial and industrial waste (also referred to as C&I waste) and construction and demolition waste (also referred to as C&D waste) into the at least one recycle product and the thermal product.

In one embodiment, the source of the waste may be aligned with the production of the thermal product with specified characteristics. For example, if an industrial process involving materials with appropriate thermal characteristics (e.g., wood working, plastics production, cardboard production and the like), creates a waste product that is well suited to the method for producing thermal products from that waste, such waste may be collected independently of municipal waste and treated with processing that is better suited to that waste type.

In another aspect, the present disclosure relates to system for processing a MSW, a C&I waste or a C&D waste into at least one recycle product and a thermal product.

According to another non-limiting aspect of the present disclosure, the system comprises: a pre-sorting component comprising at least one loader and a plurality of receptacles; a waste-processing component comprising: a shredder comprising a magnetic belt; a screening or sieving device mechanically connected with the shredder so that an end product from the shredder automatically forms a input material of the screening or sieving device; an air classifier (or a turbine separator, a pressure separator and the like) mechanically connected with the screening or sieving device so that an end product from the screening or sieving device automatically forms a input material of the air classifier; and an eddy current system (or liquid separation by density, other magnetic separation, chemical or biological separators and the like) mechanically connected with the air classifier so that an end product from the air classifier automatically forms a input material of the eddy current system; a thermal-product forming component comprising: a mixer; a mill mechanically connected with the mixer so that an end product from the mixer automatically forms a input material of the mill; an XRF system (or a thermoelectric alloy sorter, inductively coupled plasma mass spectrometry (ICP-OES), optical emission spectrometry (OES), Atomic Absorption Spectroscopy, Infrared absorption, chemical and biological sensors and the like) mechanically connected with the mill so that an end product from the mill automatically forms a input material of the XRF system; and a thermal-product-forming machine mechanically connected with the XRF system so that an end product from the XRF system automatically forms a input material of the thermal-product-forming machine; and a controller in communication with and configured to control the pre-sorting component, the waste-processing component, and the thermal-product forming component.

In one embodiment, the controller takes measurement inputs from the XRF system and wherein the controller is configured to instruct the mixer to controlled mix a cellulose-based material stockpile and a plastic-based material stockpile to form a mixture by adjusting a ratio of the cellulose-based material stockpile to the plastic-based material stockpile on the basis of the measurement inputs of at least one physical property from the XRF system.

In one embodiment, the at least one loader comprises bobcats loaders or excavators with grab or other machines that are suited to handling the input waste materials. Such machines may be complimented by human or automated special capabilities for sorting particular waste into appropriate receptacles.

In one embodiment, the pre-sorting component is configured to sort the municipal waste into a first waste comprising a majority of plastic-based material and a second waste comprising a majority of at least one cellulose-based material selected from the group consisting of paper, cardboard, wood, textile and carpet.

In one embodiment, the pre-sorting component is configured to removes bulk concrete and other low-thermal materials from the municipal waste and collects them as the at least one recycle product in the plurality of receptacles.

In one embodiment, the waste-processing component comprises a plurality of receptacles.

In one embodiment, the waste-processing component is configured to process a plastic-based material or a cellulose-based material waste into a recycle product and a plastic-based material or a cellulose-based material stockpile.

In one embodiment, the shredder may be diamond Z type shredder. Shredding may also be accomplished by grinders, chippers, impact systems and different configurations of shredders, including vertical, horizontal, rotary and the like.

In one embodiment, the diamond Z type shredder or others may be configured to shred an input material into a shredded material having pieces about 40 mm to about 60 mm in diameter.

In one embodiment, the screening or sieving device may be a trommel, a highbanker or any other sluice arrangement.

In one embodiment, the magnetic belt is configured to remove steels or other ferrous metals with magnetic properties from the first waste or the second waste and collect them in a receptacle.

In one embodiment, the trommel or others may be configured to remove soil and/or sand from a shredded material and collect them in a receptacle.

In one embodiment, the trommel or others may be configured to include a hot air blower when the shredded material is a cellulosed-based material.

In one embodiment, the air classifier or others may be configured to remove heavy materials such as rocks, bricks and heavy metals from a shredded plastic-based or cellulose-based material and collect them in a receptacle.

In one embodiment, the thermal-product forming component further comprises a plurality of receptacles.

In one embodiment, the eddy current system or others may be configured to remove non-ferrous metals such as aluminum from a shredded plastic-based or cellulose-based material and collect them in a receptacle.

In one embodiment, the thermal-product forming component is configured to process a plastic-based material stockpile and a cellulose-based material stockpile into a recycle product and a thermal product.

In one embodiment, the mixer is an industrial mixer.

In one embodiment, the mill is a hammer mill, or crushers, vibrators, mills, air knockers, and the like.

In one embodiment, the hammer mill or others may be configured to shred plastic pieces and/or cellulose-based material pieces into mixture pieces about 1 mm to about 10 mm in diameter.

In one embodiment, the XRF system or others may be configured to identify additional recycle products from mixture pieces, which are removed and collected as the recycle product.

In one embodiment, the XRF system or others may be configured to identify and removed contaminants such as PVC from a material.

In one embodiment, the thermal-product-forming machine may be a briquette machine.

In one embodiment, the system may be configured to produce the thermal product with a designable thermal property.

In one embodiment, the system may be configured to produce the thermal product with a designable thermal property by varying a ratio of a plastic-based material stockpile to a cellulose-based material stockpile.

In one embodiment, the thermal product has a thermal property in the range of about 1,000 kcal/kg to about 10,000 kcal/kg.

In one embodiment, the thermal product has a thermal property in the range of about 2,000 kcal/kg to about 9,000 kcal/kg.

In one embodiment, the thermal product has a thermal property in the range of about 3,000 kcal/kg to about 8,000 kcal/kg.

In one embodiment, the thermal product may be a briquette.

In one embodiment, the briquette is selected from the group consisting of a brown Petra with a thermal property of about 3,000 kcal/kg to about 4,000 kcal/kg, a black Petra with a thermal property of about 4,000 kcal/kg to about 5,500 kcal/kg, and a coking Petra with a thermal property of about 5,500 kcal/kg to about 7,500 kcal/kg.

In one embodiment, the recycle product comprises at least one material selected from the group consisting of glass, aluminum, soil, sand, rock, brick, ferrous metal, and non-ferrous metal and non-aluminum metal.

Additional features and advantages are described herein, and will be apparent from the following Detailed Description.

### BRIEF DESCRIPTION OF THE DRAWINGS

FIG. 1 is a diagram showing a pre-sorting/sorting component of a system according to some embodiments of the disclosure;

FIG. 2 is a diagram showing a pre-sorting/sorting component of the system according to some embodiments of the disclosure;

FIG. 3 is a diagram showing a waste-processing component of the system according to some embodiments of the disclosure;

FIG. 4 is a diagram showing a waste-processing component of the system according to some embodiments of the disclosure;

FIG. 5 is a diagram showing a waste-processing component of the system according to some embodiments of the disclosure;

FIG. 6 is a diagram showing a waste-processing component of the system according to some embodiments of the disclosure;

FIG. 7 is a diagram showing a waste-processing component of the system according to some embodiments of the disclosure;

FIG. 8 is a diagram showing a thermal-product forming component of the system according to some embodiments of the disclosure;

FIG. 9 is a diagram showing a thermal-product forming component of the system according to some embodiments of the disclosure;

FIG. 10 is a diagram showing sensors of the system according to some embodiments of the disclosure;

FIG. 11A is a diagram showing different sensors of the system according to some embodiments of the disclosure;

FIG. 11B is a diagram showing different sensors integrated with machine learning components of the system according to some embodiments of the disclosure;

FIG. 12 is a diagram showing processing management and control and management components of the system according to some embodiments of the disclosure; and

FIG. 13 is a diagram showing sensors and control and management components integrated with other components of the system according to some embodiments of the disclosure.

These and other aspects of the subject disclosure will become more readily apparent to those having ordinary skill in the art from the following detailed description of the invention taken in conjunction with the drawings.

### DETAILED DESCRIPTION OF THE INVENTION

Paper, plastics and fabric, rubber, and leather, and wood have relatively high LHV. SRF bails and unprocessed raw waste usually have high humidity and a much lower thermal power capability. Accordingly, extracting paper, plastics and fabric, rubber, leather and wood (and other high LHV components) from an incoming raw waste and removing a majority of the moisture could significantly improve the overall thermal capability of the source waste. Needed in the art are methods and systems for dynamically processing waste to remove unwanted materials, and produce a product with consistent and higher thermal output.

The example processes may include removing waste with low (e.g., miscellaneous combustibles such as nappies, sanitary products and the like), no (e.g., metals, rocks, dust, aluminum) and anti (e.g., incombustibles) thermal capabilities. Such unwanted waste sources decrease average thermal LHV of resultant thermal products produced from the waste. For example, incombustibles (e.g., brominated flame retardants (BFR) plastics) are mixtures of man-made chemicals that are added to a wide variety of products, including for industrial use to make them less flammable. The use of flame retardants (FRs), such as 1) polybrominated diphenyl ethers (PBDEs)—used in plastics, textiles, electronic castings, circuitry; 2) hexabromocyclododecane (HBCDD)—used in thermal insulation in the building industry; 3) tetrabromobisphenol A (TBBPA) and other phenols—used in printed circuit boards, thermoplastics (mainly in TVs); 4) polybrominated biphenyls (PBBs)—used in consumer appliances, textiles, plastic foams; and 5) Other brominated flame retardants. All of FRs can negatively impact the thermal capabilities and characteristics of the waste. For example, bromine, phosphorus, nitrogen and chlorine are commonly used in FRs and often form the basis of composite plastics, furniture covers and other source raw waste. Some of the example processes of the present disclosure remove FRs from the waste before producing a thermal product.

Disclosed herein are detailed descriptions of specific embodiments of methods and systems for dynamically processing waste. It will be understood that the disclosed embodiments are merely examples of the way in which certain aspects of the invention can be implemented and do not represent an exhaustive list of all of the ways the invention may be embodied. Indeed, it will be understood that the systems, methods and systems described herein may be embodied in various and alternative forms. Moreover, the figures are not necessarily to scale and some features may be exaggerated or minimized to show details of particular components and methods.

Well-known components or sub-methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention. Moreover, methods and systems are described herein as being used for processing municipal, commercial or industrial waste, but those skilled in the art will appreciate that they can be used in other waste.

Unless defined otherwise, all technical and scientific terms used herein have the same meaning as commonly understood by one of ordinary skill in the art to which this invention belongs. As used herein the following terms have the following meanings.

The term “comprising” or “comprises,” as used herein, is intended to mean that the compositions and methods include the recited elements, but not excluding others.

The term “about,” when used before a numerical designation, e.g., temperature, time, amount, and concentration, including range, indicates approximations which may vary by (+) or (−) 10%, 5% or 1%.

The term “recycle product,” as used herein, refers to any waste material that can be recycled for further use. In one embodiment, the recycle product of the present disclosure excludes any cellulose-based material and any plastic-based material that can be used to produce a thermal product. In one embodiment, the recycle product may comprise at least one material selected from the group consisting of glass, soil, sand, rock, brick, metals, building materials and others. The metals may comprise ferrous metals and other non-ferrous metals. The metals may also comprise aluminum and other non-aluminum metals.

The term “cellulose-based material,” as used herein, refers to a waste material that is originally and primarily made of cellulose or like material, e.g., paper, cardboard, some carpets, wood, some fabrics and others. For example, a cellulose-based material may comprise at least about 95%, about 90%, about 85%, about 80%, about 75%, about 70%, about 65%, about 60%, about 55%, or about 50% cellulose or like material, e.g., paper, cardboard, some carpets, wood, some fabrics and others.

The term “plastic-based material,” as used herein, refers to a waste material that is originally made of plastic or like material. For example, a plastic-based material may comprise at least about 95%, about 90%, about 85%, about 80%, about 75%, about 70%, about 65%, about 60%, about 55%, or about 50% plastic or like material.

The term “low-thermal property materials,” as used herein, refers to materials that have a thermal property below a pre-set value. In one embodiment of the present disclosure, low-thermal property materials have a thermal property below about 100 kcal/kg, or below about 50 kcal/kg, or below about 20 kcal/kg, or below about 10 kcal/kg, or below about 5 kcal/kg, or below about 3 kcal/kg, or below about 2 kcal/kg, or below about 1 kcal/kg, or below about 0.5 kcal/kg, or below about 0.3 kcal/kg, or below about 0.1 kcal/kg, or below about 0.01 kcal/kg, or below about 0.001 kcal/kg or below about 0.0001 kcal/kg.

In one embodiment, methods and systems of the present disclosure can extract and remove low-thermal property materials and other undesired materials from plastic-based or cellulose-based stockpiles before they are processed to form a briquette. As such, the briquette with a commercially viable and consistent reliable thermal capability can be produced.

In one embodiment, low-thermal property materials comprise miscellaneous combustibles such as nappies, sanitary products and the like.

The other undesired materials for the present disclosure can be those without thermal capabilities such as metals (including aluminum), rocks, dust, or others, or non-combustibles materials. The term “non-combustible material,” as used herein, refers to a substance that cannot ignite, burn, support combustion, or release flammable vapors when subject to fire or heat, in the form in which it is used and under conditions anticipated.

In one embodiment, one example of a non-combustible material is brominated flame retardants (BFR), which are usually mixtures of man-made chemicals that are added to a wide variety of products, including for industrial use, to make the products less flammable.

These low-thermal property materials and the other undesired materials, if included, would decrease average thermal lower heating value (LHV) or also known as net calorific value of the resulting thermal product.

The term “thermal product” refers to a product with a desired value of the thermal property. In one embodiment, a thermal product of the present disclosure has a thermal property at least about 800 kcal/kg, or at least about 900 kcal/kg, or at least about 1000 kcal/kg, or at least about 1500 kcal/kg, or at least about 2000 kcal/kg, or at least about 2500 kcal/kg, or at least about 3000 kcal/kg, or at least about 3500 kcal/kg, or at least about 4000 kcal/kg, or at least about 4500 kcal/kg, or at least about 5000 kcal/kg, or at least about 5500 kcal/kg, or at least about 6000 kcal/kg.

In one embodiment, the thermal product is a briquette. Methods and systems of the present disclosure can process municipal, commercial or industrial waste to consistently and controllably produce a briquette with a pre-defined thermal and other characteristics.

In one embodiment, the thermal product of the present disclosure has a thermal property significantly greater than that produced from burning the corresponding raw materials.

In one embodiment, the thermal product of the present disclosure has an average thermal property close to any high quality thermal coal coking coal (e.g., 5,470 kcal/kg).

In one embodiment, the thermal property of the thermal product of the present disclosure can be automatically controlled through adjusting different parameters of methods and systems of the present disclosure. Thus, thermal products of the present disclosure can have a thermal property, e.g., in the range of brown coal equivalent or high enough to fall into coking coal thermal categories.

In one embodiment, methods and systems of the present disclosure can also control other characteristics of the resulting thermal product such as a briquette. For example, a briquette of the present disclosure can have humidity of less than 35%, or less than 30%, or less than 25%, or less than 20%, or less than 15%, or less than 10%, or less than 5%. Preferably, a briquette of the present disclosure can have humidity of less than 10%. As a comparison, humidity of coal can be as high as 40% or more.

The term “processing,” “processed,” or “process,” as used herein, refers to both separating low-thermal property materials and/or other undesired materials from a waste (e.g., municipal, commercial or industrial waste) and collecting them as recycle products, and producing a thermal product such as a briquette with a desirable and controllable thermal property from the waste.

In one aspect, the present disclosure relates to a system for dynamically processing waste. The system can process a municipal, a commercial, an industrial waste or any other kind of waste. In one preferred embodiment, the system can process a municipal waste. The system may include a pre-sorting/sorting component 100, a waste-processing component 200, a thermal-product forming component 300, and a control and sensor management component 400.

### Pre-Sorting/Sorting Component

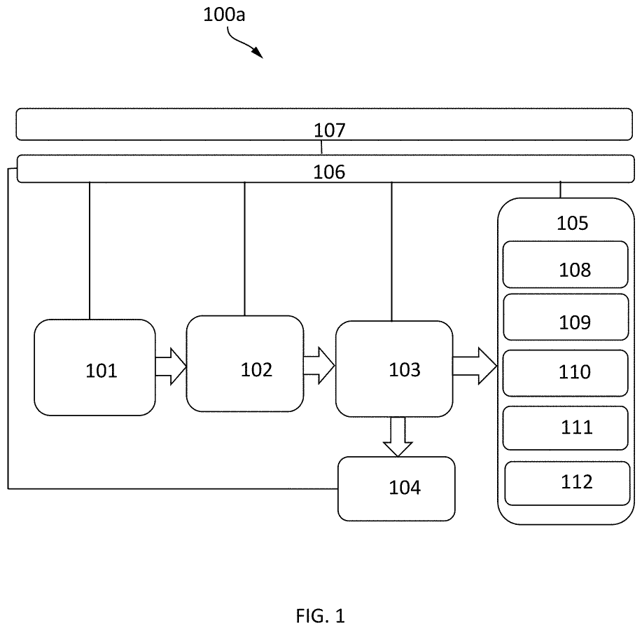

FIG. 1 illustrates an exemplary pre-sorting/sorting component 100a. Waste is initially delivered to a delivery space 101. The waste is then moved to a pre-sorting space 102.

A sorting vehicle or loader 103 then picks up the waste from the pre-sorting space 102 and manually or automatically sorts the waste into different categories of cellulosed-based materials and/or plastic-based materials in each of a plurality of receptacles 105.

For example, the sorting vehicle or loader 103 can sort the waste into different categories of materials such as those comprising predominately paper 108, those comprising predominately plastic 109, those comprising plastic and wood 110, those comprising wood 111, and those comprising other cellulose-based or plastic-based materials 112.

Further, the sorting vehicle or loader 103 can identify and remove from the waste any large and undesired plastic materials such as PVC and BFR, any recycle product such as rock and glass, and any other large noticeable low-thermal property materials such as building materials into a removable receptacle 104.

As shown in FIG. 1, each part of the pre-sorting/sorting component 100a may be monitored by a sensor system 106. The sensor system 106 comprises a plurality of sensors and each of the sensors is configured to evaluate status of the waste and generates information sets that are passed to a control and management system 107. The control and management system 107 automatically reviews and analyzes the information set from the sensor system 106, and sends any necessary commend to each part of the pre-sorting/sorting component 100a (e.g., the sorting vehicle or loader 103) to further process the waste.

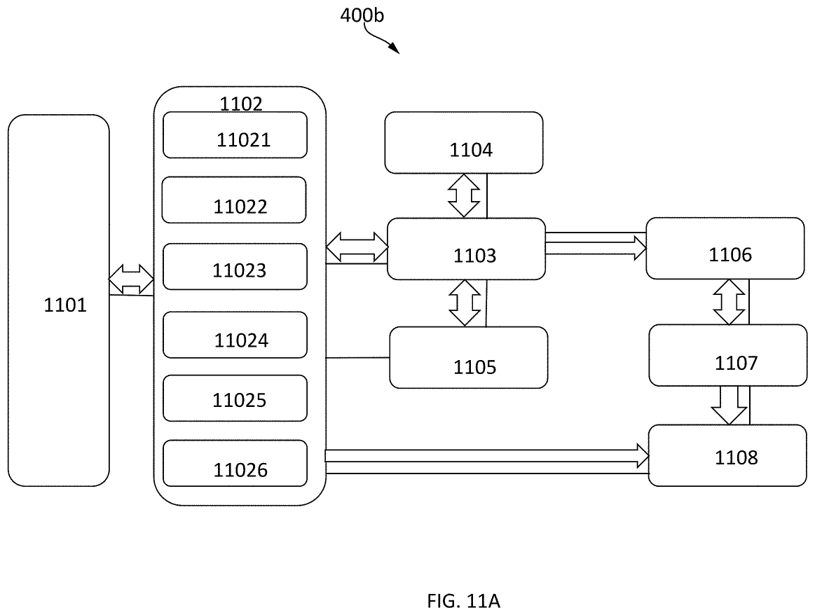

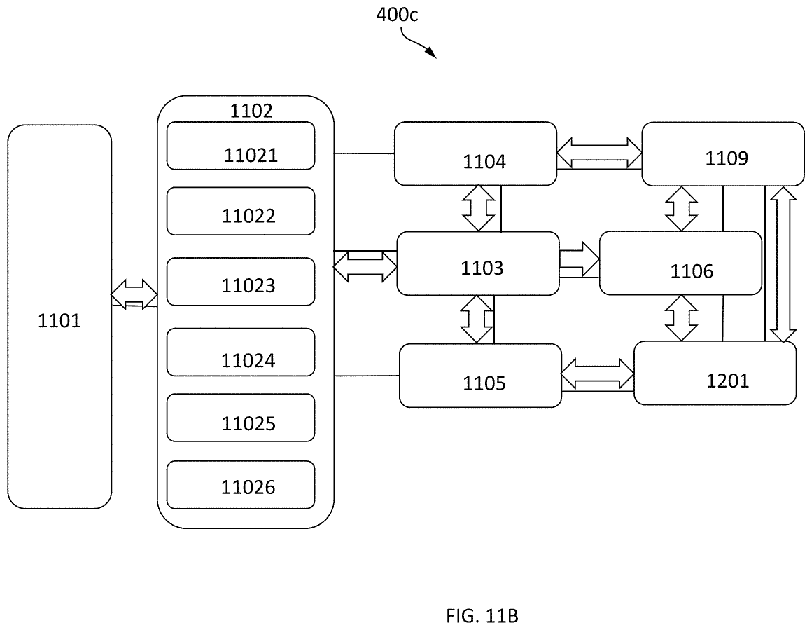

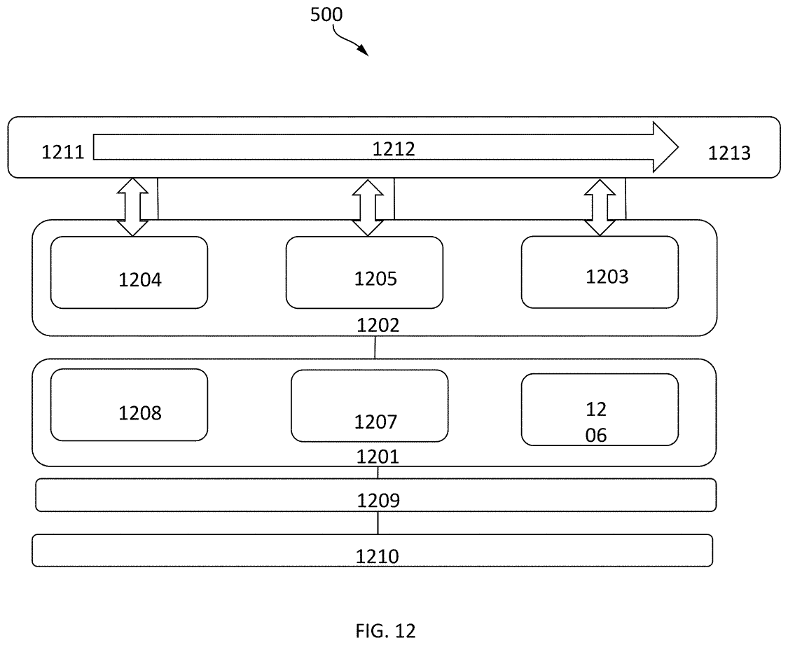

Materials collected in the removable receptacle 104 may include rocks, metals, glass and other undesired materials. These materials may be deposited in separate containers or receptacles for further processing or handling, such as recycling. Status of these materials (e.g., quantities and qualities) maybe recorded, through the sensor system 106, to form one part of a record. The record may include an immutable record stored in an immutable ledger (see FIGS. 11A and 12).

The pre-sorting/sorting component 100a may be configured to ensure that the plurality of receptacles 105 comprises predominately the materials as described above. However, the materials within the plurality of receptacles 105 may likely include some contaminants, such as food, water, oils, soil, rocks, metals, aluminum, glass and the like. The sensor system 106 may be configured to identify these contaminants and further identify specific types of plastics, wood, and paper that form the majority of the materials, and generate related information sets that are passed to the control and management system 107.

The control and management system 107 may review and analyze the related information sets to further configure and commend the subsequent processing of the waste. For example, the control and management system 107 may commend moving any of the plurality of receptacles 105 to wherever such a material is needed for processing in anywhere of the disclosed system.

In one alternative, the sorting vehicle or loader 103 comprises a bobcat loader, or a plurality of bobcat loaders. The plurality of bobcat loaders may be configured to be automatically monitored by the sensor system 106 and automatically controlled by the control and management system 107. Other sorting vehicles or loading systems may also be used, for example excavator with grab or other machines that are suited to handling the input waste materials. Such machines may be complimented by human or automated special capabilities for sorting particular waste into appropriate receptacles.

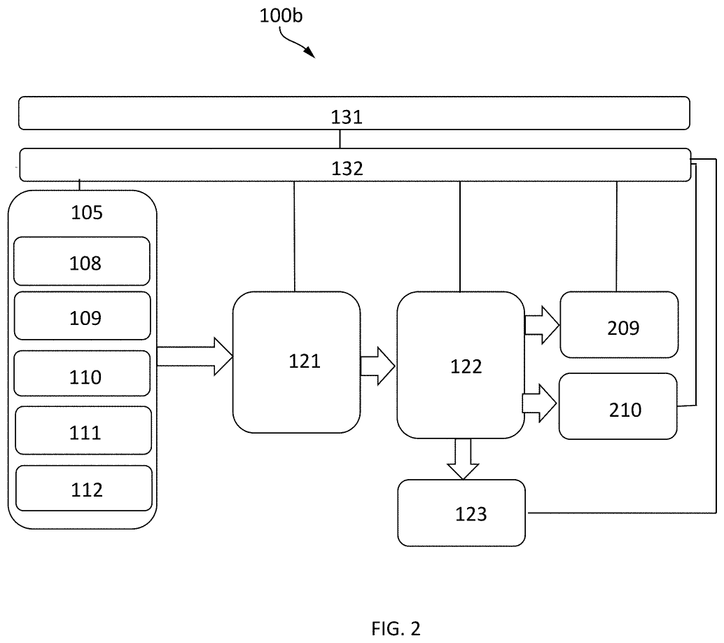

Referring now to FIG. 2, another exemplary pre-sorting/sorting component 100b is depicted. The pre-sorting/sorting component 100b may further process the resulting material categories produced by the pre-sorting/sorting component 100a into two categories of predominately cellulosed-based materials and predominately plastic-based materials.

As shown in FIG. 2, the different categories of materials such as those comprising predominately paper in receptacle 108, those comprising predominately plastic in receptacle 109, those comprising plastic and paper in receptacle 110, those comprising wood in receptacle 111, and those comprising other cellulosed-based or plastic-based materials in receptacle 112 among the plurality of receptacles 105 are automatically moved to a further sorting space 121. The system, may be configured such that the receptacle 108 and the receptacle 109 may be directly connected to 121, as may be the receptacles 110, 111 and 112 in any arrangement may be connected to 121. The sorting space, 121, enables the separation of the materials into a plastic rich waste stream and a cellulose rich waste stream. In the case where the waste is pre-sorted or is the output of an industrial process which is plastic-rich, cellulose-rich or both, depending on the degree of contaminants, these streams may be passed directly to 121 or 122.

A secondary sorting vehicle or loader 122 then picks up the different categories of materials from the further sorting space 121 and sorts them into two categories of predominately cellulosed-based materials and predominately plastic-based materials. These two categories of materials are separately stored in one removable receptacle 209 for the plastic-based materials, and one removable receptacle 210 for the cellulose-based materials.

For example, the secondary sorting vehicle or loader 122 can separate the materials comprising plastic and wood, e.g., from receptacles 110, into either plastic-based materials or cellulose-based materials.

The pre-sorting/sorting component 100b may also have a removable receptacle 123 in which further contaminants and recycle products from the different categories of materials may be collected and stored.

As shown in FIG. 2, each part of the pre-sorting/sorting component 100b is monitored by a sensor system 132. The sensor system 132 comprises a plurality of sensors and each of the sensors is configured to evaluate status of the waste and generates information sets that are passed to a control and management system 131. The control and management system 131 automatically reviews and analyzes the information set from the sensor system 132, and sends any necessary commend to each part of the pre-sorting/sorting component 100b (e.g., the sorting vehicle or loader 122) to further process the waste.

The sorting vehicle or loaders 103 and 122 may be manually and/or automatically controlled. Further, either pre-sorting/sorting component 100a or 100b may further include subsystems for facilitating manual sorting. In one alternative embodiment, the system may be fully automated. In another alternative embodiment, a user may manually assist any part of the component 100a or 100b. It will be appreciated that different combinations of both manually and automatically sorting processes may take place in any combination in the pre-sorting/sorting component 100a or 100b.

For example, selection and ordering of such manually and automatically sorting processes may be determined and commended by the sensor systems 106 and 132 and the control and management systems 107 and 131.

In one embodiment, the specific categories of the materials that is removed from the waste is then deposited into receptacles such as 104, 123 and 108-112 for each type and may be subject to further processing, recycling, storage or transferring to other facilities.

For example, the sensor systems 106 and 132 and the control and management systems 107 and 131 may identify the specific types, compositions and quantities (both relative and actual in the waste sorting processing) of the materials. This information may be stored in one or more immutable or other repositories, which are, in some embodiments, part of the sensor systems and the control and management systems (see FIG. 11A).

### Waste-Processing Component

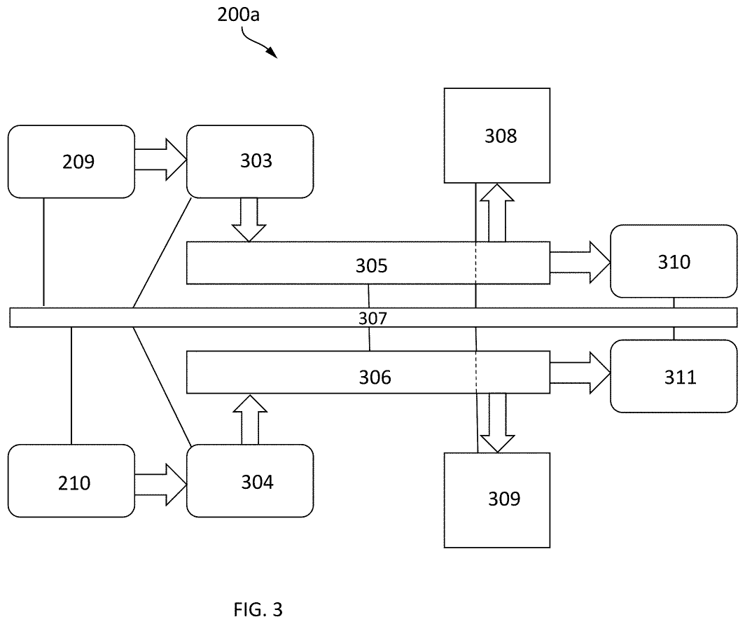

Referring now to FIG. 3, a waste-processing component 200a of the system according to some embodiments of the disclosure is depicted. For example, the waste-processing component 200a can separately process the plastic-based materials from the removable receptacle 209 and the cellulose-based materials from the removable receptacle 210 into a plastic rich stream and a cellulose rich stream respectively, comprising predominately of material pieces of their respective types.

Specifically, the waste-processing component 200a can shred the plastic-based materials of 209 and the cellulose-based materials of 210 into the corresponding material pieces of suitable size that can be placed on magnetic belt conveyers 305 and 306. The magnetic belt conveyers 305 and 306 can isolate any ferrous metal materials from the material pieces. It will be appreciated that other forms of magnetic separation may also be employed as an alternative to a magnetic belt.

The input materials for the waste-processing component 200a may be either directly transferred from the resulting materials from the sorting vehicle or loader 103. Specifically, the input materials for the waste-processing component 200a may be the different categories of materials such as those comprising predominately paper in receptacle 108, those comprising predominately plastic in receptacle 109, those comprising plastic and wood in receptacle 110, those comprising wood in receptacle 111, and those comprising other cellulosed-based or plastic-based materials in receptacle 112.

In one embodiment, the input materials for the waste-processing component 200a may be the resulting materials from the secondary sorting vehicle or loader 122. Specifically, the input materials for the waste-processing component 200a may be the plastic-based materials from the removable receptacle 209 and the cellulose-based materials from the removable receptacle 210.

As shown in FIG. 3, the waste-processing component 200a may include the removable receptacle 209 (storing predominately the plastic-based materials, which form the plastic rich stream, produced from the pre-processing), a plastic shredder 303, a first magnetic belt conveyer 305, a first metal bin 308 and a removable receptacle 310 for plastic that has been processed by the shredder 303. The removable receptacle 209, the plastic shredder 303, the first magnetic belt conveyer 305, and the removable receptacle for plastic pieces 310 may be sequentially and mechanically connected with one another. For example, output from the plastic shredder 303 become input materials to the first magnetic belt conveyer 305. Output from the first magnetic belt conveyer 305 become input materials to the removable receptacle for plastic pieces 310.

The plastic shredder 303 may be any shredder than can shred to a sufficiently small size e.g., about 40 mm to about 60 mm. For example, shredding may be accomplished by grinders, chippers, impact systems and different configurations of shredder, including vertical, horizontal, rotary and the like.

The waste-processing component 200a may also include the removable receptacle 210 (storing predominately the cellulose-based materials, which form the cellulose-based material rich stream, produced from the pre-processing), a paper shredder 304, a second magnetic belt conveyer 306, a second receptacle for metals 309 and a removable receptacle 311 for cellulose-based material pieces.

The paper shredder 304 may be any shredder than can shred to a sufficiently small size e.g., about 40 mm to about 60 mm, while still reliably coping with streams of somewhat mixed materials.

The removable receptacle 210, the shredder 304, the second magnetic belt conveyer 306, and the removable receptacle for cellulose-based material pieces 311 may be sequentially and mechanically connected with one another. For example, output products from the shredder 304 become input materials to the second magnetic belt conveyer 306. Outputs from the second magnetic belt conveyer 306 may be used as inputs to the removable receptacle for cellulose-based material pieces 311.

As shown in FIG. 3, the waste-processing component 200a may also include a sensor/control and management system 307. The sensor/control and management system 307 may have a plurality of sensors configured to monitor each part of the waste-processing component 200a, and facilitate their control.

The waste-processing component 200a may be configured to shred the plastic-based and cellulose-based materials into plastic pieces and cellulose-based material pieces with an average diameter between about 10 mm and about 90 mm, between 20 mm and about 80 mm, between about 30 mm and about 70 mm, or between about 40 mm and about 60 mm, preferably between about 40 mm and about 60 mm, more preferably about 60 mm. The resulting plastic pieces and cellulose-based material pieces may have an average surface area between about 100 mm² and about 10000 mm², between about 400 mm² and about 8000 mm², between about 1000 mm² and about 6000 mm², between about 1500 mm² and about 5000 mm², or between about 2000 mm² and about 4000 mm², preferably between about 2000 mm² and about 4000 mm².

The parameters (e.g., average sizes of the cellulose-based material pieces or the paper-based material pieces) of such pieces may be determined at least in part by the sensor/control and management system 307, which in turn may be informed by the sensors deployed in previous stages of the system, as illustrated by FIGS. 1 and 2.

These shredded materials from 303 and 304, are then passed to the transport devices, e.g., magnetic conveyer belts 305 and 306, which are configured to isolate and remove any ferrous metal materials from the shredded materials.

The waste-processing component 200a may be configured to separate any ferrous metals, e.g., by using a magnetic sorter, and then deposit them in the first and the second bins 308 and 309. The ferrous metals may then be further recycled or transferred to another facility.

During the above process, the sensor/control and management system 307 is configured to identify and categorize the materials of each stage of the process. The sensor/control and management system 307 may also monitor and manage the operations of the shredders 303 and 304 and magnetic conveyors 305 and 306 to ensure an optimal output of the process. For example, the sensor/control and management system 307 may monitor and manage the process by controlling average sizes of materials during the shredding process, adjusting speed of the magnetic conveyor belts and intensity of the magnetic force applied. The sensors of the sensor/control and management system 307 may collect further information for evaluation and storage as discussed above.

The waste-processing component 200a produces an output mixture that is mainly plastic pieces, referred to here as plastic-rich waste stream, and another output mixture that is mainly cellulose-based material pieces, referred to here for convenience as cellulose-rich waste stream, which are stored in the removable receptacles 310 and 311 respectively. The plastic rich waste stream and cellulose rich waste stream in the removable receptacles 310 and 311 may be transferred directly to a waste-processing component 200b for further processing.

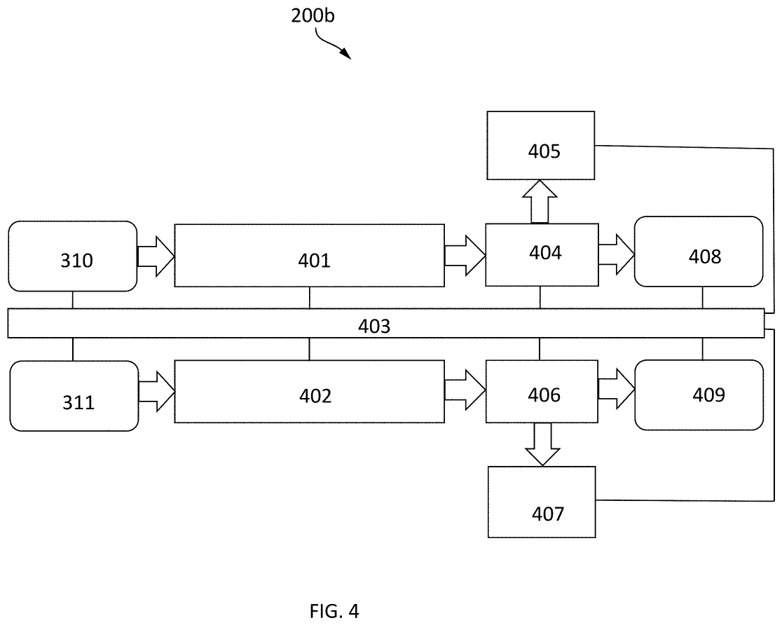

Referring now to FIG. 4, the waste-processing component 200b is depicted. As shown in FIG. 4, the waste-processing component 200b comprises the removable receptacle 310 for the plastic-rich waste stream, an aerated screening or sieving device 401, an eddy current system 404, a removable receptacle 408 for purified plastic-rich waste stream having a higher proportion of plastic pieces and a bin 405 predominately for aluminum. For example, the removable receptacle 310 for plastic pieces in the plastic-rich waste stream, an aerated screening or sieving device 401, an eddy current system 404, and a removable receptacle 408 for purified plastic pieces may sequentially and mechanically connected with one another. For example, output products from the aerated screening or sieving device 401 become input materials to the eddy current system 404. Ending products from the eddy current system 404 become input materials to the removable receptacle for purified plastic pieces 408.

The waste-processing component 200b may include the removable receptacle 311 for cellulose-based material pieces, a second aerated screening or sieving device 402, a magnetic belt 406, a removable receptacle 409 for purified cellulose-based materials, having a higher proportion of cellulose-based material pieces and a bin 407 for ferrous metals. For example, the removable receptacle 311 for cellulose-based material pieces, the second aerated screening or sieving device 402, the magnetic belt 406, and the removable receptacle 409 for purified cellulose-based material pieces may be sequentially and mechanically connected with one another. For example, output products from the second aerated screening or sieving device 402 become input materials to the magnetic belt 406. Output products from the magnetic belt 406 become input materials to the removable receptacle for purified cellulose-based material pieces 409.

As shown in FIG. 4, the waste-processing component 200b may have a sensor/control and management system 403. The sensor/control and management system 403 comprises a plurality of sensors configured to monitor each part of the waste-processing component 200b. There may also be feedback systems to help control the various components.

Any screening or sieving device may be used in the waste-processing component 200b. For example, the screening or sieving device may be a trommel, highbanker or other sluice arrangements.

The aerated screening or sieving devices 401 and 402 may be aerated trommels. The aerated trommel 401 may be configured for low or no heat for processing the streams containing mostly plastic pieces. The aerated trommel 402 may be configured for heating the cellulose-based material pieces, in order to reduce the stored moisture content of such materials.

The waste-processing component 200b may alternatively include a single trommel which is reconfigurable for use with differing materials, or multiple devices configured for different modes for each type of material. The configuration of the trommels may in part be determined by the information sets collected by the related sensors in the preceding steps.

For example, moisture content, types of materials, mass and other physical measurements may be used to determine configuration parameters of the trommels. The output of this process is materials with a reduced amount of contaminants for the further processing steps. The process may also removal of any metals from the materials.

Cellulose-based waste materials such as woods, paper, cardboard and carpets may arrive as sodden with moisture. Such waste materials will benefit from at least one heat treatment to remove or reduce the moisture content. In some embodiments, this objective can be achieved by passing the shredded cellulose-based waste materials through warm air trommels where the air heat is, preferably, a maximum 30 degrees centigrade or any other suitable temperature.

A further trommel may also be used to remove further dust, soil and organics through the sieves, once the shredded waste is dried in the warm aired trommel.

Both aerated trommels 401 and 402 may be configured with different heat levels and other settings such that output product of this process is optimized for further application of an Eddy current system. The management of the moisture content is highly desirable because it has may have a significant impact on the thermal and binding characteristics of the resulting briquettes. As such, trommels 401 and 402 may be used to produce target profiles for the various materials ingested to optimize the performance of this processing and the end briquette characteristics.

XRF systems analysis may be used and configured to retain plastics with a certain size that match the surface area required for the optimum energy profile of the output of the system, including briquettes and other feedstock with consistent and configured thermal characteristics.

In one embodiment, input materials for the waste-processing component 200b may be directly transferred from distal end of the magnetic belt conveyers 305 or 306. Alternatively, the input materials for the waste-processing component 200b may be transferred from the removable receptacle 310 for the plastic rich stream comprising plastic pieces and from the removable receptacle 311 for the cellulose rich stream comprising cellulose-based material pieces. The plastic rich stream containing mostly plastic pieces may be passed through the aerated trommel 401 that is configured for low or no heat to ensure that the plastic pieces suitable for further processing and consequent formation of briquettes. For example, low heat may added in the aerated trommel 401 to remove or reduce moisture content of the plastic pieces. In one embodiment, the moisture content of the plastic pieces may be monitored, determined and controlled by the sensor/control and management system 403.

The plastic pieces after the aerated trammel 401 are transferred through a conveyor to the eddy current system 404. The eddy current system 404 is configured to remove any aluminum from the plastic pieces and the aluminum is then deposited into the bin 405 for further recycling or processing. Other metals that are responsive to eddy currents may also be similarly removed. Throughout the system, an eddy current system such as 404 may use static electricity to attract plastics and paper to remove aluminum as a contaminant. There are currently many versions of the eddy current systems available. Many of them may be suitable for integration into the system and many of them may have suitable interfaces to be configured by the control and management system of the system.

Other alternative techniques may be used to separate plastics from other wastes in the system. For example, van der graff generators or similar machines may use the triboelectric effect to attract plastic pieces to a repository for separation. Liquid separation by density, other magnetic separation, chemical or biological separators and the like may also be used in the system.

The cellulose-based material pieces are passed through the aerated trommel 402 configured to heat the cellulose-based material pieces to achieve a specified moisture content level. In one embodiment, the specified moisture content level is less than 30%, less than 20%, or less than 10%, preferably less than 10%. A humidity sensor and feedback control may be used to control this process.

The stream containing mostly cellulose-based material pieces is subsequently transferred to the magnetic belt conveyor 406 to remove any ferrous metals. These ferrous metals may be deposited in the metal bin 407 for further recycling or processing. During the above process, the sensor/control and management system 403 is configured to identify and categorize the material pieces at each stage and to monitor and manage the operations of the trommels 401 and 402, the magnetic conveyor system 406 and the eddy current system 404 to ensure an optimal output of the process.

The waste-processing component 200b produces a purified stream containing mostly plastic pieces and purified stream containing mostly cellulose-based material pieces, which are stored in the removable receptacles 408 and 409. The purified plastic stream and purified cellulose-based material stream in the removable receptacles 408 and 409 may be transferred directly to a waste-processing component 200c for further processing.

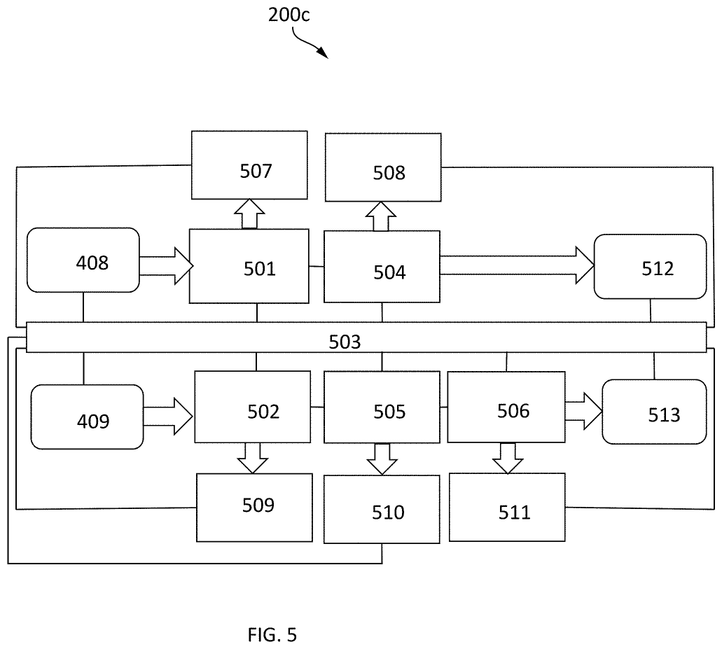

Referring now to FIG. 5, the waste-processing component 200c is depicted. As shown in FIG. 5, the waste-processing component 200c comprises the removable receptacle 408 for purified plastic pieces, an X-ray Fluorescence (XRF) or infrared spectrometer 501, an air classifier 504, a removable receptacle 512 for plastic stockpile, a bin 507 for plastics/glass and a bin 508 for rocks/heavy materials.

The waste-processing component 200c further comprises the removable receptacle 409 for purified stream of cellulose-based material pieces, an eddy current system 502, a second XRF spectrometer 505, a second air classifier 506, a removable receptacle 513 for cellulose-based material stockpile, a bin 509 for aluminum, a second bin 510 for plastics/glass and another bin 511 for rocks/heavy materials.

As shown in FIG. 5, the waste-processing component 200c includes a sensor/control and management system 503. The sensor/control and management system 503 comprises a plurality of sensors configured to monitor and control each part of the waste-processing component 200c.

In one embodiment, input materials for the waste-processing component 200c may be directly transferred from one end of the eddy current system 404 for the purified plastic pieces or from a distal end of the magnetic belt system 406 for the purified cellulose-based pieces.

In another embodiment, the input materials for the waste-processing component 200c may be transferred from the removable receptacle 408 for purified plastic pieces and from the removable receptacle 409 for purified cellulose-based material pieces.

The purified plastic pieces are passed through the XRF or infrared system 501, which is configured to identify (by their chemical compositions) and remove any undesired glass and plastics and/or to maximize the amount of polyethylene terephthalate (PET) plastics in stockpile. In one alternative, the XRF or infrared system 501 may identify and remove any polyvinyl chlorides (PVCs), glass, and/or BFRs. The non-limiting examples of the XRF or infrared system include Steinert KSS or XF L.

Alternatively, other identification systems such as thermoelectric alloy sorter, inductively coupled plasma mass spectrometry (ICP-OES), optical emission spectrometry (OES), Atomic Absorption Spectroscopy, Infrared absorption, chemical and biological sensors and the like may also be used in the system.

The purified plastic pieces may then be processed through the air classifier 504, which is configured to separate lighter plastic from any heavy contaminants such as rocks, sands and the like.

The air classifier 504 is used as an exemplary system. Other alternative systems such as turbine separator, pressure separators and the like may be also used instead of the air classifier 504.

In one embodiment, a number of input parameters of the air classifier 504 may be configured and adjusted, such as the volume and/or speed of the air in the classifier, humidity levels, temperature of air column and others. For example, depending on the types of plastics, the air column of the air classifier 504 may be varied accordingly in order to optimize contaminant removal and/or vary characteristics of the plastics for subsequent processing. The characteristics may include separation by density of the materials, such as paper. The heavier paper products may be treated by different configurations if they predominate in a particular batch of waste materials. The purified output stream of plastic pieces may then form the plastics stockpile in the removable receptacle 512, which is designated the plastics feedstock.

The purified cellulose-based material pieces are initially passed through the eddy current system 502 to remove any aluminum, which is stored in the bin 509. The purified cellulose-based material pieces are subsequently passed through the second XRF system 505, as described herein, to remove undesired plastics and glass, which are deposited into the bin 510.

The purified cellulose-based material pieces are then passed through the air classifier 510 to remove any heavy materials, which are stored in the bin 511. The purified cellulose-based material pieces may then form the cellulose-based material stockpile in the removable receptacle 513, which is designated the cellulose feedstock.

During the above process, the sensor/control and management system 503 is configured to identify and categorize the material pieces at each stage and to control and manage the operations of the XRF spectrometers 501 and 505, air classifiers 504 and 506 and the eddy current system 502 to ensure an optimal output of the process.

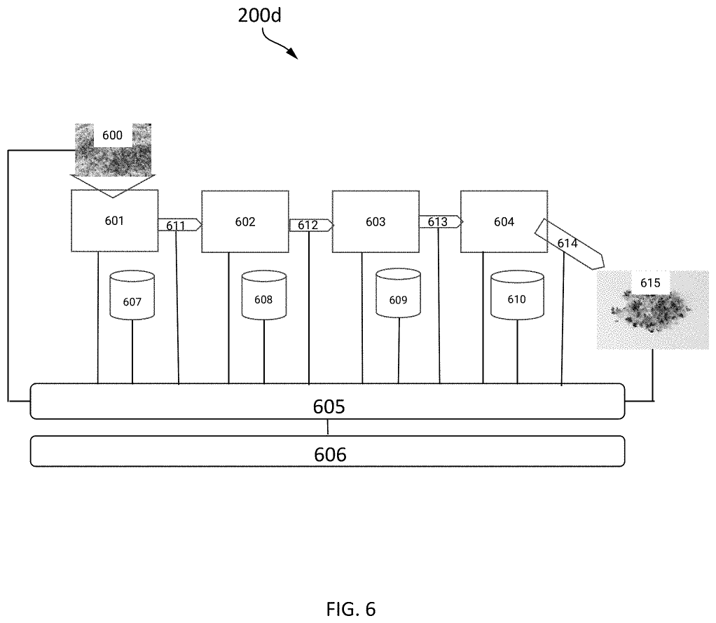

Referring now to FIG. 6, a waste-processing component 200d of the system according to some embodiments of the disclosure is depicted. For example, the waste-processing component 200d manually or automatically receives plastic-based materials directly from the system or from any removable receptacle such as the removable receptacle 209. The waste-processing component 200d can shred the plastic-based materials into plastic pieces of suitable size, and further separate ferrous metals, sand and/or soil, rocks and/or bricks and aluminum from the plastic prices to form a plastic-based stockpile.

As shown in FIG. 6, the waste-processing component 200d comprises a plastic source 600, a shredder with a magnetic belt 601, mechanically connected through a conveyor 611 to a screening or sieving device 602, which is mechanically connected through a conveyor 612 to an air classifier 603. The air classifier 603 is mechanically connected through a conveyor 613 to an Eddy current system 604, which is further mechanically connected through a conveyor 614 to a removable receptacle 615 for the resulting plastic-based stockpile.

The waste-processing component 200d further comprises a plurality of receptacles including one receptacle 607 for ferrous metals from the shredder with a magnetic belt 601, one receptacle 608 for sand and/or soil from the screening or sieving device 602, one receptacle 609 for rocks and/or bricks from the air classifier 603, and one receptacle 610 for aluminum from the eddy current system 604.

As shown in FIG. 6, each part of the waste-processing component 200d is monitored by a sensor system 605. The sensor system 605 comprises a plurality of sensors and each of the sensors is configured to evaluate status of plastic materials, plastic pieces and plastic stockpile at each stage and generates information sets that are passed to a control and management system 606. The control and management system 606 automatically reviews and analyzes the information set from the sensor system 605, and sends any necessary commend to each part of the waste-processing component 200d to further process the plastic materials and/or the plastic pieces.

For example, the sensor system 605 and the control and management system 606 may monitor and manage the process by varying shredder operating parameters to control the average sizes of plastic pieces produced during the shredding process, adjusting speed of the magnetic conveyor belts and intensity of the magnetic force applied.

In another example, the sensor system 605 and the control and management system 606 may monitor and manage the process by controlling the moisture content of the plastic pieces.

In one embodiment, the screening or sieving device 602 is a trommel. Optionally, the trommel may include a heating device such as a hot air blower to remove and control the moisture content of the plastic pieces.

Alternatively, the screening or sieving device 602 may be any other suitable machine such as highbanker or other sluice arrangements.

The plastic-based materials from the plastic source 600 are initially shredded by the shredder with a magnetic belt 601 into plastic pieces with an average diameter between about 10 mm and about 90 mm, between 20 mm and about 80 mm, between about 30 mm and about 70 mm, or between about 40 mm and about 60 mm, preferably between about 40 mm and about 60 mm, more preferably about 60 mm.

The shredder with a magnetic belt 601 is further configured to separate ferrous metals from the plastic pieces and store them in the receptacle 607 for further recycling or processing. In one embodiment, the shredder with a magnetic belt 601 is a diamond Z type shredder. After leaving the shredder, the stream containing the plastic pieces are then transferred through the conveyor 611 to the screening or sieving device 602.

Alternatively, Shredding may be accomplished by grinders, chippers, impact systems and different configurations of shredder, including vertical, horizontal, rotary and the like.

The screening or sieving device 602 is configured to remove any sand and/or soil from the plastic pieces. The sand and/or soil are stored in the receptacle 608 for further recycling or processing. The stream containing the plastic pieces are subsequently transferred through the conveyor 612 to the air classifier 603.

Alternatively, the air classifier 603 may be substituted by any suitable systems such as turbine separator, pressure separators and the like.

The air classifier 603 is configured to separate lighter plastic pieces from any heavy contaminants and recycle products such as rocks, sands and the like, which are stored in the receptacle 609 for further recycling or processing. The stream containing the plastic pieces are then transferred through the conveyor 613 to the eddy current system 604.

Alternatively, the eddy current system 604 may be substituted by other suitable systems such as liquid separation by density, other magnetic separation, chemical or biological separators and the like.

The eddy current system 604 is configured to remove any aluminum from the plastic pieces and the aluminum is then deposited into the receptacle 610 for further recycling or processing. The plastic pieces are then transferred through the conveyor 714 to the removable receptacle 615, forming the plastic-based stockpile.

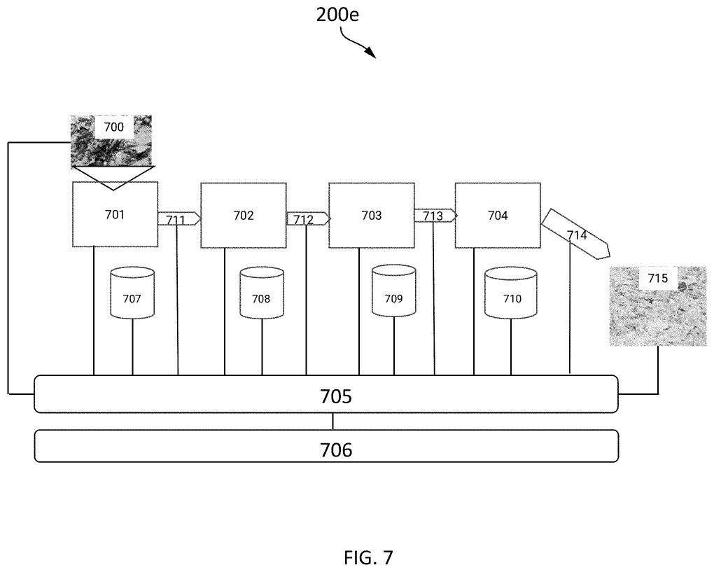

Referring now to FIG. 7, a waste-processing component 200e of the system according to some embodiments of the disclosure is depicted. In different alternatives, the waste-processing component 200e manually or automatically receives cellulose-based materials directly from the system or from any removable receptacle such as the removable receptacle 210.

The waste-processing component 200e can shred the cellulose-based materials into cellulose-based material pieces of suitable size, and further separate ferrous metals, sand and/or soil, rocks and/or bricks and aluminum from the cellulose-based material prices to form a cellulose-based stockpile.

As shown in FIG. 7, the waste-processing component 200e may include a cellulose-based material source 700, a shredder with a magnetic belt 701, mechanically connected through a conveyor 711 to an aerated screening or sieving device 702, which is mechanically connected through a conveyor 712 to an air classifier 703. The air classifier 703 is further mechanically connected through a conveyor 713 to an Eddy current system 704, which is further mechanically connected through a conveyor 714 to a removable receptacle 715 for the resulting cellulose-based stockpile.

The waste-processing component 200e further comprises a plurality of receptacles including one receptacle 707 for ferrous metals from the shredder with a magnetic belt 701, one receptacle 708 for sand and/or soil from the aerated screening or sieving device 702, one receptacle 709 for rocks and/or bricks from the air classifier 703, and one receptacle 710 for aluminum from the Eddy current system 704.

As shown in FIG. 7, each part of the waste-processing component 200e may be monitored by a sensor system 705. The sensor system 705 comprises a plurality of sensors and each of the sensors is configured to evaluate status of cellulose-based materials, cellulose-based material pieces and cellulose-based stockpile at each stage and generates information sets that are passed to a control and management system 706. The control and management system 706 automatically reviews and analyzes the information set from the sensor system 705, and sends any necessary commend to each part of the waste-processing component 200e to further process the plastic materials and/or the plastic pieces.

For example, the sensor system 705 and the control and management system 706 may monitor and manage the process by varying average sizes of cellulose-based material pieces during the shredding process, adjusting speed of the magnetic conveyor belts and intensity of the magnetic force applied.

When the sensor system 705 and the control and management system 706 detect that a physical property such as average sizes, moisture content, purity of the cellulose-based material pieces fails to meet a pre-set value, the sensor system 705 and the control and management system 706 can automatically commend returning the cellulose-based material pieces to a certain process to improve the physical property to meet such a pre-set value.

Further, the sensor system 705 and the control and management system 706 may monitor and manage the process by controlling the moisture content of the cellulose-based material pieces.

In one embodiment, the screening or sieving device 702 is an aerated trommel.

Alternatively, the screening or sieving device 702 may be any other suitable machine such as highbanker or other sluice arrangements.

The aerated trommel is configured to heat the cellulose-based material pieces to achieve a specified moisture content level. In one embodiment, the specified moisture content level is less than 30%, less than 20%, or less than 10%, preferably less than 10%.

The cellulose-based materials from the source 700 are initially shredded by the shredder with a magnetic belt 701 into cellulose-based material pieces with an average diameter between about 10 mm and about 90 mm, between 20 mm and about 80 mm, between about 30 mm and about 70 mm, or between about 40 mm and about 60 mm, preferably between about 40 mm and about 60 mm, more preferably about 60 mm.

In one embodiment, the shredder with a magnetic belt 701 is a diamond Z type shredder.

Alternatively, Shredding may be accomplished by grinders, chippers, impact systems and different configurations of shredder, including vertical, horizontal, rotary and the like.

The shredder with a magnetic belt 701 is further configured to separate ferrous metals from the cellulose-based material pieces and store them in the receptacle 707 for further recycling or processing.

The cellulose-based material pieces are then transferred through the conveyor 711 to the aerated screening or sieving device 702.

The aerated screening or sieving device 702 is configured to remove any sand and/or soil from the cellulose-based material pieces. The sand and/or soil are stored in the receptacle 708 for further recycling or processing.

Further, as discussed above, the aerated screening or sieving device 702 is also configured to remove and control the moisture content level of the cellulose-based material pieces. In one embodiment, the specified moisture content level may be actively controlled, e.g., to product a stream of the cellulose-based material pieces with a moisture content less than 30%, less than 20%, or less than 10%, preferably less than 10%. The cellulose-based material pieces are subsequently transferred through the conveyor 712 to the air classifier 703.

Alternatively, the air classifier 703 may be substituted by any suitable systems such as turbine separator, pressure separators and the like.

The air classifier 703 is configured to separate lighter cellulose-based material pieces from any heavy contaminants and recycle products such as rocks, sands and the like, which are stored in the receptacle 709 for further recycling or processing. The cellulose-based material pieces are then transferred through the conveyor 713 to the eddy current system 704.

Alternatively, the eddy current system 704 may be substituted by other suitable systems such as liquid separation by density, other magnetic separation, chemical or biological separators and the like.

The eddy current system 704 is configured to remove any aluminum from the cellulose-based material pieces and the aluminum is then deposited into the receptacle 710 for further recycling or processing.

The cellulose-based material pieces are then transferred through the conveyor 714 to the removable receptacle 715, forming the cellulose-based stockpile.

### The Thermal-Product Forming Component

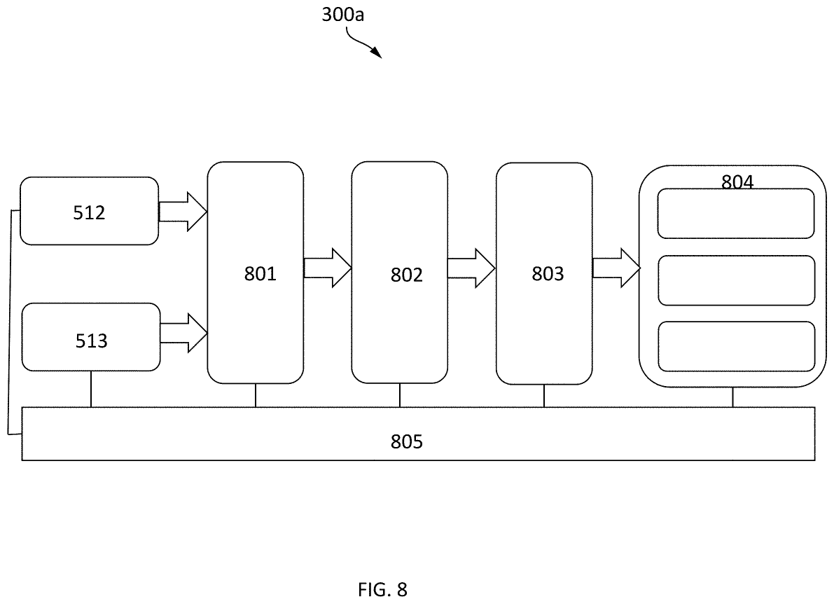

Referring now to FIG. 8, a thermal-product forming component 300a of the system according to some embodiments of the disclosure is depicted. The thermal-product forming component 300a mixes the plastic-based stockpile and the cellulose-based stockpile in a controlled proportion into a mixture, which is then further processed to form thermal products such as feedstock and/or briquettes with controllable and consistent thermal property.

The term “plastic-based stockpile,” as used herein, refers to a stockpile comprising primarily plastic-based materials. For example, a plastic-based stockpile may comprises at least about at least about 95%, about 90%, about 85%, about 80%, about 75%, about 70%, about 65%, about 60%, about 55%, or about 50% plastic or like material.

The term “cellulose-based stockpile,” as used herein, refers to a stockpile comprising primarily cellulose-based materials. For example, a cellulose-based stockpile may comprise at least about 95%, about 90%, about 85%, about 80%, about 75%, about 70%, about 65%, about 60%, about 55%, or about 50% cellulose or like material, e.g., paper, cardboard, some carpets, wood, some fabrics and others.

Depending on the intended application of the feedstock or briquettes, the mixture and characteristics of these outputs may be varied in accordance with the intended application. For example, if the feedstock is to replace coal in the generation of heat for cement, electricity, metal (ferrous and non-ferrous) production or similar activities, the thermal and physical characteristics of the feedstock or briquettes may be varied according to the specifications for the optimization of that process. For example, the thermal characteristics of the feedstock may be configured to be similar to those of bituminous coal and coke, providing a higher calorific value, which is preferred in cement production. In electricity production, the thermal characteristics may be optimized for driving a turbine and subsequent generator, through production of steam or other gas transfer agent, use in thermocouples or thermoelectric devices.

Each of the application areas has specific specifications for the heat elements of their production processing. These Specifications may be used by the control and management systems to optimize the feedstock and briquettes to meet those specifications.

As shown in FIG. 8, the thermal-product forming component 300a comprises the removable receptacle 512 for plastic stockpile, the removable receptacle 513 for cellulose-based material stockpile, a mixing system 801, a mixed material store 802, a briquette preparation shredder 803, a machine 804 and a sensor/control and management system 805.

The removable receptacles 512 and 513 may be used as input sources of plastic-based and cellulose-based stockpiles. It will be appreciated that other input sources may also be used. For example, the removable receptacle 615 may be used as a source of plastic-based stockpile. The removable receptacle 715 may also be used as a source of cellulose-based stockpiles.

As shown in FIG. 8, the plastic-based stockpile from the removable receptacle 512 and the cellulose-based stockpile from the removable receptacle 513 are fed to the mixing system 801, where a pre-set ratio of these two stockpiles are uniformly mixed to form a mixture suitable for the intended application domain. In one alternative, the pre-set ratio of the two stockpiles is monitored, determined and actively controlled by the sensor/control and management system 805, such that a specific and controllable thermal property can be achieved in the resulting thermal product such as a briquette or feedstock.

In one embodiment, the mixing system 801 is an industrial mixer. The non-limiting examples of the industrial mixer may include Yargus rotary 16t blender.

The mixture of these two stockpiles are then stored the mixed material store 802. In some embodiments, the thermal-product forming component 300a may comprise multiple stores like 802 to store mixtures with different ratios of these two materials for different feedstock and briquette compositions. These compositions may be aligned with specific applications, such as cement manufacture, electricity generation, metal production and the like.

For example, to prepare for briquette production, the mixture is further shredded in the briquette preparation shredder 803 so that the average sizes of the material pieces in the mixture are further reduced. Similarly, a shredder for feedstock production may also be employed, where any of the input materials may be shredded so as to provide characteristics that meet the application requirements. A direct transportation of the feedstocks to the machine 804 may also be included. It may be achieved through forcing the feedstock into the kiln through a pipe in a stream, which will include the appropriate air to fuel mixture for the intended application. In this manner, the sizing of the materials of the feedstock can impact the transport to the machine 804, and as such the transport mechanism may be constructed so as to not impeded this process.

For example, the mixture of plastic pieces and the cellulose-based material pieces are further shredded into mixture pieces about 30 mm to about 50 mm in diameter, about 20 mm to about 40 mm in diameter, about 10 mm to about 30 mm in diameter, about 8 mm to about 20 mm in diameter, or about 5 mm to about 10 mm in diameter, preferably about 5 mm to about 10 mm in diameter.

In one approach, addition of any further ingredients for binding is not necessary for the briquette formation. For example, after the further shredding process, the mixture pieces can bind well together without the need of any further binding ingredients during the briquette formation. In an alternative approach a binder may be added to the mixture. Burnable binders, such as starches, molasses or other sugar residue, or gum Arabic may be used in some applications. Non-burnable binders, such as clays may also be used, although they potentially increase the amount of unburned residue when the thermal product is burned.

During the above process, the sensor and control and management system 605 is configured to identify and categorize the stockpiles, the material pieces and mixture pieces at each stage and to monitor and manage operations of each part of the component 300a such as the mixing system 801, the store 802, the shredder 803 and the briquette production machine 804 to ensure an optimal output of the process.

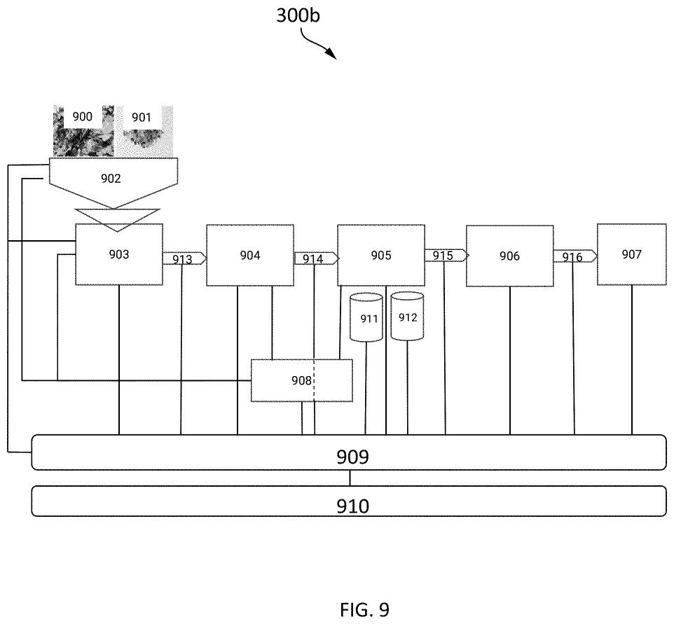

Referring now to FIG. 9, a thermal-product forming component 300b of the system according to some embodiments of the disclosure is depicted. The thermal-product forming component 300b is configured to controlled mix the plastic-based stockpile and the cellulose-based stockpile in a pre-set ratio into a mixture, which is further processed to form thermal products such as feedstock (e.g., fluff feedstock) and briquettes with controllable and consistency thermal property.

As shown in FIG. 9, the thermal-product forming component 300b comprises a cellulose-based stockpile source 900, a plastic-based stockpile source 901, a collector and feeder 902 for collecting and feeding the stockpiles, a mixer 903 for mixing the stockpiles, mechanically connected through a conveyor 913 to a hammer mill 904.

Further, the hammer mill 904 is mechanically connected through a conveyor 914 to a XRF spectrometer 905, and the XRF spectrometer 905 is mechanically connected through a conveyor 915 to a briquette machine 906. The briquette machine 906 is further mechanically connected through a conveyor 916 to a receptacle 907 for storing the final briquette products.

As shown in FIG. 9, the thermal-product forming component 300b further comprises a quality-control system 908. The quality-control system 908 is at least in directed communication with the XRF spectrometer 905, the collector and feeder 902 and the mixer 903.

The thermal-product forming component 300b comprises a receptacle 911 for collecting glasses identified and remove by the XRF spectrometer 905 from the mixture pieces.

The thermal-product forming component 300b comprises another receptacle 912 for collecting other recycle products and contaminations identified and remove by the XRF spectrometer 905 from the mixture pieces. In one embodiment, the recycle products and contaminations may include PVC or any other materials, which may have negative effect on the resulting thermal products for both efficient burn and emissions.

The thermal-product forming component 300b further comprises a sensor system 909 and a control and management system 910.

As shown in FIG. 9, each part of the thermal-product forming component 300b is monitored by the sensor system 909. The sensor system 909 can comprise a plurality of sensors and each of the sensors is configured to evaluate status of cellulose-based and plastic pieces, mixture pieces and briquettes at each stage and generates information sets that are passed to the control and management system 910. The control and management system 910 automatically reviews and analyzes the information set from the sensor system 909, and sends any necessary commend to each part of the thermal-product forming component 300b to further process the plastic-based, cellulose based material pieces, the mixture pieces, thus to ensure quality of the final products such as briquettes.

For example, the sensor system 909 and the control and management system 910 can monitor, control and maintain quality of the final products such as briquettes by controlling the quality control system 908.

Alternatively, the sensor system 909 and the control and management system 910 can monitor, control and maintain quality of the final products such as briquettes by controlling and managing each part of the thermal-product forming component 300b.

As shown in FIG. 9, the cellulose-based stockpile from the source 900 and the plastic-based stockpile from the source 901 are fed through the collector and feeder 902 into the mixer 903.

Any of the source 900, the source 901, the collector and feeder 902 and the mixer 903 is in communication with the quality control system 908 and is further monitored and managed by the sensor system 909 and the control and management system 910.

For example, at any given time, either the quality control system 908 or the control and management system 910 can review and analyze related information sets from the sensor system 909 and determine a desired ratio of the cellulose-based stockpile to the plastic-based stockpile. Either the quality control system 908 or the control and management system 910 can send a timely command with the desired ratio to the source 900, the source 901, the collector and feeder 902 and the mixer 903. One or more of the source 900, the source 901, the collector and feeder 902 and the mixer 903 can then enforce the command by feeding the desired ratio of materials from the cellulose-based stockpile to the plastic-based stockpile into the mixer 903 into the system.

In one embodiment, the mixer 903 is an industrial mixer. A non-limiting examples of the industrial mixer may include Yargus rotary 16t blender. The mixer 903 can thus ensure that a specific ratio of the cellulose-based stockpile to the plastic-based stockpile are uniformly mixed into a first mixture. The first mixture is then transferred through the conveyor 913 to the hammer mill 904. It will be appreciated that other kinds of mills can also be used to shred the first mixture.

The hammer mill 904 is configured to shred the first mixture into pieces with a pre-determined size to form a second mixture.

Alternatively, shredding may be accomplished by grinders, chippers, impact systems and different configurations of shredder, including vertical, horizontal, rotary and the like.

In one embodiment, the pre-determined size is determined and controlled by either the quality control system 908 or the control and management system 910.

In one embodiment, the plastic pieces and the cellulose-based material pieces of the first mixture are further shredded into a second mixture with mixture pieces about 30 mm to about 50 mm in diameter, about 20 mm to about 40 mm in diameter, about 10 mm to about 30 mm in diameter, about 8 mm to about 20 mm in diameter, or about 5 mm to about 10 mm in diameter, preferably about 5 mm to about 10 mm in diameter.

The second mixture is then transferred through a conveyor 914 to the XRF spectrometer 905.

The XRF spectrometer 905 is configured to identify (by chemical compositions) and remove any undesired glass and plastics to maximize the amount of polyethylene terephthalate (PET) plastics in the stockpile.

In one embodiment, the XRF spectrometer 905 may also identify and remove any polyvinyl chlorides (PVCs), glass, and/or BFRs. The glass is stored in the receptacle 911 and the others are stored in the receptacle 912.

Further, the XRF spectrometer 905 is also configured to measure at least one physical property of the second mixture.

In one embodiment, the at least one physical property further comprises one or more of density, purity, wetness and average sizes of the cellulose-based material pieces or the paper-based material pieces. In another embodiment, the at least one physical property comprises one or more of density, purity, weight, thermal capability (measured in kcal/kg), Combustion Efficiency, direct and ambient heat at varying pressure levels (similar to pressure levels in end use kilns), wetness and average sizes of the cellulose-based material pieces or the paper-based material pieces.

In one embodiment, the XRF spectrometer 905 is configured to provide and update time-dependent measurements of the at least one physical property of the second mixture to the quality control system 908 and the control and management system 909.

Alternatively, other suitable identification systems such as thermoelectric alloy sorter, inductively coupled plasma mass spectrometry (ICP-OES), optical emission spectrometry (OES), Atomic Absorption Spectroscopy, Infrared absorption, chemical and biological sensors and the like may be used.

In one embodiment, the quality control system 908 and/or the control and management system 909 review and analyze the time-dependent measurements of the at least one physical property of the second mixture, determine a desired ratio of the cellulose-based material stockpile to the plastic-based material stockpile at any given time, subsequently instruct the related parts of the thermal-product forming component 300b to enforce or adjust the ratio accordingly.

The second mixture is then transferred through the conveyor 915 to the briquette machine 906. It will be appreciated that other thermal-product forming machines can be also used in the present disclosure. The non-limiting examples of the briquette machine may include RUF 400, 800 or Lignum or other systems that can produce a formed briquette from our resultant feedstock and in sufficient tonnage per hour.

The briquette machine 906 is configured to provide a predefined level of pressure to form a solid briquette with optimal burn efficiency. It will be appreciated this pressure might be actively controlled based on various measurements of the product streams, and based on the type of briquette being produced.

For example, Table 2 shows pressure in pascals required for different briquette compositions.

TABLE 2
Pressure and briquette compositions.

| | pressure | |
|---|---|---|
| | required | |
| | to form a | |
| Cellulose/ | briquette | |
| Plastic % | (in pascals) | Emissions |
| 80/20 | 200-250 | None |
| 50/50 | 250-300 | None |
| 20/80 | 400-500 | None |

In one embodiment, the quality control system 908 and the control and management system 910 take inputs from the XRF spectrometer 905. These inputs are reviewed and analyzed and the quality control system 908 and the control and management system 910 send corresponding instructions to ensure the quality of thermal products. For example, if the size of the mixture pieces is too big, the quality control system 908 and the control and management system 910 can instruct the hammer mill 904 to process the mixture for a longer time. If the mixture includes too much plastic and/or too much paper, the XRF spectrometer would detect such densities and send such a feedback to the quality control system 908 and the control and management system 910. The quality control system 908 and the control and management system 910 can then instruct the mixer 903 to mix for a longer period of time (if the issue is insufficient mixing) or to adjust the relative quantities of the input stockpiles (if the issue is persistent rather than just tied to particular points in the mixture). The issue might be determined by monitoring the variability of the measurements over time.

If the estimated thermal content (e.g., in Kcal) is too low or too high for the resulting briquettes, the quality control system 908 and the control and management system 910 can instruct changing the mixing ratio accordingly.

If there are high levels of unwanted waste or too high moisture in the material pieces, the control and management system 910 which is integrated into the system can instruct the related parts or related components (see FIGS. 1-9) to vary the time application as required.

For all the figures discussed herein, one or more intermediate stores may be additional included. For example, intermediate stores may provide physical spaces where any materials can be stored for a period of time before being passed to the next step of processing.

In some embodiments, should any materials be deemed to have not met pre-set values of the specifications in terms of contaminants, moisture content, weight, size or other parameters, the materials may be passed by using removable receptacles or intermediate stores through one or more processes repeatedly until such pre-set values of the specifications are met.

For example, one or more intermediate stores may be added to components, such as that of FIG. 5, to store stockpile of materials, plastic pieces and cellulose-based material pieces, which are eventually used to make the briquettes.

In another alternative, one or more intermediate stores may be dynamically used in the system. For example, after materials are loaded into the one or more intermediate stores, the materials may also be quickly transferred from the one or more intermediate stores into any of the briquette processing steps.

Although each of the steps is described in this embodiment and other embodiments in a specific sequence, one may vary the order of these processes to suit different conditions, size, speed and other operational characteristics of the system.

### Sensor System and Devices

The system may employ a sensor system comprising a plurality of sensors and devices throughout each component of the system. For example, each of the pre-sorting/sorting component 100a and 100b, the waste-processing component 200a, 200b, 200c, 200d and 200e, and the thermal-product forming component 300a and 300b may comprise a plurality of sensors and devices throughout each part of the components.

In one embodiment, additional sensors and devices may be included during waste ingestion, processing, briquette production, briquette burn and energy generation. The information set obtained from each sensor may be integrated with that of other sensors at the same processing stage, sensors across multiple sensor stages and sensors covering the complete lifecycle of waste to energy operations.

Each sensor may be used to identify a specific aspect of the materials being processed, to create a profile for the materials that are to be used in the production of the briquettes and/or to identify any contaminants or recycle products for that purpose. The sensors may be configured to provide sufficient information regarding any configuration of processing steps following the information capture by the sensors and to provide information which the overall control system can use to create briquettes with varying thermal, emission and residue characteristics.

The information sets obtained from the sensors may be stored in at least one data repository, which may include distributed ledgers, to create an audit trail for the processing. These information sets may include analysis of any characteristics of a waste material, which can inform manufacture of an original product comprising the waste material, as to the characteristics of the original products in the waste to energy production cycle.

Thus, the information sets may be used in active control, to vary product composition, to partially reduce emissions, to increase thermal output, to reduce residue or in any other manners to increase the efficiency during disposal of these products.

Such information sets may be collected and presented in such a manner to be used for financial or other consequences associated with the production and/or recycling of such products. For example, the original products that are more easily and efficiently converted from waste to energy, may benefit from lower financial burdens, such as any recycling taxes, other charges or receive other financial and/or value based benefits.

In some embodiments, various combinations of different wastes that are typical to be processed may be used to establish profiles for various sensors in the process. As such, the sensors may be configured in such a manner that known characteristics, metrics and quantities in the different wastes can be captured with sufficient accuracy, creating the initialization of the configuration of these sensors.

A set of test waste materials, with different compositions, contaminants, moisture content and other characteristics indicative of the types of the same waste materials, may be evaluated by the sensors systems at each stage of the process to establish reference profiles for these waste materials.

The information sets can then be used as inputs to configure the control and management system of the system and/or a machine learning system, to provide reference categorizations. As such, operations of such systems may be improved dynamically.

Any original waste may be, optionally, in the form of a Solid Recovered Fuels (SRF) bale. The original waste may undergo a set of measurements to establish a set of baseline metrics for any incoming waste, e.g., for a particular bale, or for bales from a particular source.

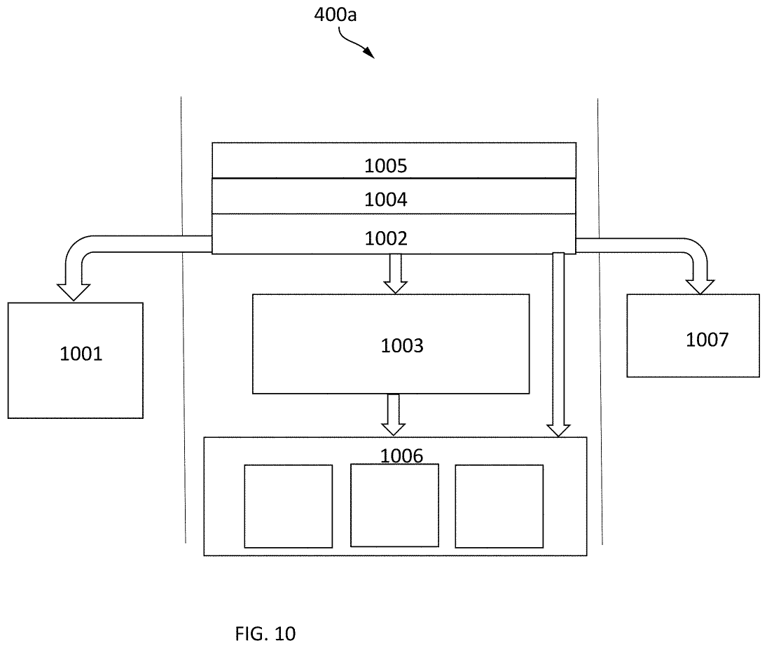

Referring now to FIG. 10, a system 400a comprising a sensor system 1002 for an initial waste sorting process are depicted. As shown in FIG. 10, an incoming waste, any related method and any type of delivery 1001 are monitored by a plurality of sensors. For example, the plurality of sensors can be set up in the waste sorting process 1003, in the contaminants removing process 1006 and in the transferring process 1007. Information sets obtained by the sensor system 1002 can be transferred to a control and management system 1005.

Information sets obtained by the sensor system 1002 may include typical delivery information provided by a transporter, such as delivery dockets, weights, source of materials, time and the like. Such information may be received manually or automatically.

In some embodiments, the information sets may be digitally transferred from a vehicle or an occupant thereof through a suitable device and communications protocol and medium, for example Wi-Fi or Bluetooth.

In one embodiment, the plurality of sensors of the sensor system may also measure at least one physical property of any waste.

In one embodiment, such measurement may be undertaken at any point of originally arrival of the waste, during transit of the waste to any processing facility or at any processing facility. An initial measurement may include, weight, moisture, composition and dimensions. If a measurement is undertaken prior to arrival of each waste, the related information set may be written to a distributed ledger, directly or through a repository 1004 configured for that purpose, so as to create an immutable record.

Further, additional measurements may be undertaken after the waste arrives at the processing facility to confirm any previous readings and evaluate any differences during transit.

In one embodiment, the measurements of the sensor system may be used to determine volume, mass, characteristics and types of materials in a waste. The information sets may be delivered to the control and management system 1005 for creating the thermal outcomes of resulting briquettes from the materials.

One type of sensor may be a camera, which can capture images of the incoming waste and delivery mechanism. For example, the information may be captured as a video at a frame rate suitable for further processing or as individual snapshots bound to a trusted timing mechanism. The period between each snapshot may be insufficient for the quantity of materials to be significantly varied, for example through removal or addition of materials.

In one embodiment, a delivery area may be under CCTV observation, for example for security purposes. Under the same timing mechanism as discussed above, a CCTV observation may provide a means to detect any variations in the waste. For example, each waste delivery may be captured by the sensor system 1002 comprising at least one camera with a clear view of the incoming materials. Multiple cameras may also be used, for example to capture different perspectives of an incoming waste. Further, multiple cameras may be combined to provide a 3D rendition of the materials.

The sensor system 1002 may also include thermal sensors. For example, thermal sensors may include infrared sensors, which can be configured to provide information as to the temperature and moisture content of any incoming waste. The information set may be further processed by the control and management system 1005 to detect the amount of materials with a high water content. Such information set may be used by the control and management system 1005 to configure further process to remove or reduce the moisture content.

The moisture levels of a waste may be determined directly or indirectly by the sensor system 400a. For example, infrared sensors may be used to measure humidity. The sensors such as thermal sensors may be integrated into the floor of the waste sorting processing space 1003. The sensor system may further include a drain to capture and measure the amount and type of water or other contaminants that is responsible for the moisture content. The sensor system 400a may further include a drain system under the waste sorting that captures water from the waste, providing a volumetric measure of the water content.

The sensors may be arranged and configured to capture the waste from multiple perspectives, enabling the creation of a three dimensional (3D) view of the waste. These 3D views may be recorded and bound to a trusted time, to be stored in the repository 1004.

The sensors may also be used together with lasers, and associated sensors capable of measuring diffraction and absorption of laser light by the waste materials by using different filters and frequencies. The information set may be used in combination with the other sensors to identify the composition and characteristics of any incoming waste.

In one embodiment, the sensors can measure degree of reflectivity of waste materials. For example, upon arrival, each waste bale may be measured for reflectivity, such that any composition of the bale may be determined based on the reflection and absorption of the sensor emitted frequencies by the contents of the waste.

As such, the sensors may be used together with emitters for UV, visual and NIR frequency ranges of light to establish reflective profiles for waste materials. For example, plastics have different spectral reflectance from other materials. The spectral reflectance of plastics may be exacerbated by degree of contaminants attached to the plastics. Thus, spectral reflectance during the processing can be used to inform configurations of subsequent processing.

In some embodiments, the sensor system 1002 may comprise multiple sensors providing information sets related to moisture content quantities of the waste under examination.

The sensor system 1002 may further measure weights of a waste, providing characteristics of the waste. For example, at each stage of the process, the weight of the waste may be measured and considered to determine the amount and type of content of the waste. The related information set may be used to configure the processing steps of the waste.

For example, a reference waste sample may be used to establish typical measures, e.g., mean, median, standard deviation, for a typical waste combination. Material deviations from the anticipated weight may be measured and used to configure subsequent process of a waste.

If the weight of a waste is higher than the median weight, the type of contaminants may be evaluated to be soil, rocks, metals and the like. Such evaluation may be mediated by the moisture content of the same waste. As such, operations of an aerated trammel as discussed above may be varied to account for these characteristics.

In one embodiment, outcome of the initial ingestion process may include a bale composition profile comprising metrics obtained by the sensor system 1002. For example, the metrics may include weight, dimensions, composition (plastic/dry paper and cardboard/wet paper and cardboard, Moisture). Within the composition metrics, types of plastics may be further characterized.

In some embodiments, one or more sensors may be used to capture, evaluate, store and generate information sets of a waste at any given time. For example, the waste may be monitored by the sensors after the waste is received at a processing location, prior to, during and after the processing of the waste into appropriate materials. The waste may also be monitored by the sensors during any stage of the creation of briquettes with specific thermal characteristics. The information sets can be used to dynamically configure the individual and overall processes to the corresponding waste.

The one or more sensors may include any combination of emitters and/or sensors. For example, an emitter may subject an incoming waste to a specific frequency of emission, in the visible region, near visible region or radio frequency band (RF). The emitter may include one producing high frequencies such as those used by radar (both surface and ground), lidar, x-rays and the like.

The image data captured by appropriate sensors may then be processed by using common image processing systems with sets of digital filters to identify characteristics of a waste.

Identification may particularly focus on chemical compositions and/or specific elements of a waste, for example any types of plastic and paper. In one embodiment, degree of noise in the signal captured by such sensor systems may be correlated to any amount of any contamination in the waste. For example, specific peaks may be associated with the presence of metals, glass or other unwanted contaminants.

In some embodiment, initial analysis may produce images or other data of low resolution, wherein a noise floor is sufficiently high to obscure many of the elements of a waste. For example, a return signal for a paper waste is likely of low intensity compared to a metal or other heavy materials.

The initial measurements may be stored in an appropriate repository. In some embodiments, such information sets of the initial measurements may be recorded in an immutable ledger, so as to establish an audit trail for any incoming waste.

As the process as described above is repeated for each waste, the measurements and related information sets are accumulated and stored in the system. As such, a continuous identification refinement of waste materials may be undertaken. For example, the identification refinement may be used to improve the signal to noise ratios of initial measurements to show each identified element of a waste.

Each of the processes may be monitored by at least one optical, thermal, infrared or ultraviolet sensitive camera. The cameras can cover a wide range of visual and nonvisual frequencies, thus providing a detailed information set of the waste processing.

In one embodiment, the information set may be well suited to machine learning techniques.

Each image may be processed by using common image processing algorithms to evaluate the reflections of the SRF. For example, each light may be independently controlled and exposure time for capturing the image may be configured. When a processing time is short, the total image process may be in the range of 1 to 3 seconds.

In one embodiment, an image captured by a camera may be analyzed to determine many different aspects of the bale content.

Each bale may be irradiated with a light of at least one frequency and temperature. For example, an LED light can typically range from 2700 k, which is “warm,” to 6000 k, which is “crisp white.” In some embodiments, a light may comprise three or four LED lights configured and arranged to provide a consistent light. The three or four LED lights may be segmented across a range of temperatures to provide distinctive reflections based on that range of temperatures, and consequently frequency of the emitted light.

A spectrum profile for reflectivity and absorption of a waste may be created to reflect different chemical compositions of the waste and any contaminations.

The spectrum profile may comprise individual images for each capture of various lighting emissions and their integration.

Each image may be treated by using digital filters, to identify material types within a bale. For example, metals (such as tin, steel and aluminum) and plastics all have high reflectivity and all have different frequency distributions for different light sources.

A water content of paper and cardboard elements of a bale may also be determined by using this method.

In some embodiments, a waste may be exposed to a UV light source. For example, PVC plastics are resistant to the UV light, and thus provide a different frequency profile of absorption and reflectivity as compared with PET. As such supporting an identification of such materials can be accomplished.

Different colors in plastics such as PET may also be used to identify and evaluate the content of such plastics in a bale. Similarly, colors of PVC, cardboard, glass, metal, soil and other contaminants may be used to identify and evaluate such waste types at any stage of the process.

An aggregated information data sets may be integrated by using techniques such as Fourier Transforms, Discrete Wavelet transformation, Gabor transform, Wigner transform and/or other time and frequency distribution functions in any combination or arrangement.

In one embodiment, the computational intensity versus accuracy of the analysis may be considered when a particular rate of ingestion of waste and subsequent briquette production is specified.

During the initial configuration, the analytics may be conducted on sample waste ingestions to produce as accurate information sets as possible. Reference profiles are formed and used as templates for matching against incoming waste during production.

Certain reference waste bales with known combinations of waste are created to form a reference framework to which any information sets for an incoming waste may be compared.

Techniques for identifying the composition difference between the reference and an incoming waste may be used. For example, the closest reference to an incoming waste may comprise 10% soil, 5% glass, 32% cardboard/paper, 27% PET plastic, 4% metal, 10% PVC and 12% unidentified.

The incoming waste may then be classified in terms of the data from the closest reference (e.g., the closest reference bale may have a specific identifier): Incoming bale=Reference bale ID (Soil −1, Glass+3, Cardboard/paper+3, PET −1, Metal+1, PVC −2, Unidentified +1).

The above information may be recorded in at least one repository, including a distributed ledger. The information may be tracked throughout the process such that each stage of the process may be evaluated for efficiency and be continuously monitored for waste material compositions for making briquettes.

The sensors may be used to evaluate an incoming waste and track such waste throughout the process, to determine briquette compositions, briquette combustion and residue and emissions therefrom. The sensors may measure one or more of translucence, magnetic properties, thermal absorption characteristics, mass, temperature, moisture, volume, color, reflectivity and the like.

For example, Ground Penetrating Radar (GPR) may be used to identify and evaluate water content. Other RF emission techniques may be used to identify other particular characteristics of a waste.

A spectroscopy technique such as X-ray fluorescence (XRF) may be used at any stage of the processing to identify and determine materials in any waste. Such technique can provide identification of any contaminants in the waste, which is useful for determining ratios of different materials to make the briquettes.

Referring now to FIG. 11A, a system 400b comprising an exemplary sensor system 1102 is depicted.

As shown in FIG. 11A, the sensor system 1102 may be used to establish the contents of the reference waste materials that are used to calibrate the machine learning systems (see FIG. 11B), and provide a reference set of information for baseline configuration of the processing systems.

As shown in FIG. 11A, the sensor system 1102 may comprise any of the sensors illustrated from 11021 to 11026, in any combination, with their sensing operations being undertaken in any arrangement.

Specifically, suitable sensors may include a camera 11021 using visible, IR or UV light, a spectrograph 11022, an emitter 11023 such as laser, UV or NIR emitter, an emitter 11024 using a LED, a transceiver 11025 or an ANO (Another) 11026.

In one embodiment, the sensors may include ultra sound or other sonic techniques along with contact based evaluations, such as drains fitted with water sensors to measure moisture run off and the like.

A visual camera 11021 may capture an image in coordination with emissions from at least one LED light source 11024. By using the same timing mechanism as discussed above, the emission intensity, color (frequency) and elapsed time may be locked to the camera configuration, such as shutter speed, white balance, aperture, auto focus and the like.

The initial settings for these multi-sensor evaluations may be established as the reference information sets. These multi-sensor systems may then be used to provide a data set with consistent configuration, which can be used by the machine learning system (see FIG. 11B) to reduce the noise variables in a signal and as consequence establish the primary contents of the waste in real time. Other combinations of sensors, in any arrangement, may be used to establish the contents and a condition of the waste, for example by directly or indirectly measuring water content.

The sensor system 1102 may be controlled by a sensor emitter control system 1103, which may include a trusted reference time base and a trusted location. After the processing of a waste is established to have occurred at a specific time and place, each of the individual processes related to the waste can be referenced to the same trusted time and location references.

In one embodiment, the system 400b may include a further system providing information to align the coordination of the emitters and sensors. Timing and other configuration information may be passed to the sensor and emitter control system 1103, by an emitter and sensor coordination module 1104.

In some embodiments, the system may include information sets calculated by a machine learning system (See FIG. 11B), where variations to the coordination may have been calculated to be beneficial to evaluation of the waste.

For example, if an initial evaluation of the waste is determined by the system 400b to be too noisy or not to provide sufficient information about the contents, the system 400b may vary the coordination of the emitters and sensors to create a further set of information, which is a better match to a reference information sets, or a set of information that the machine learning system has created.

The configurations used consistently with the sensors and emitters may be stored and managed by the configuration module 1105. In some embodiments, such configuration sets may include parameters for evaluating any indicia on the materials, for example recycling indicia on plastics, cardboard and others.

Once the sensor and emitters have undertaken the evaluation of the waste, the information sets may be passed to the information sets management module 1106.

In one embodiment, the information sets management module 1106 may be integrated with the machine leaning system (see FIG. 11B; 1109) and a control and management system (FIG. 11B; 1201).

In some embodiments, a repository 1107 may be used to provide persistence and organization of the information sets. The repository 1107 may include organizations and schemes to support any operating waste process and the generation of reporting and other summary, such as operational dashboards and/or representations.

A distributed ledger 1108 may be used to capture and provide an immutable store of the processing of the waste. It can include any of the processes undertaken by the deployed systems, the information sets, the methods applied, the outcomes and any configurations employed.

The information sets stored in the ledger 1108 may then be used to establish an immutable audit trail. In some embodiments, the information sets can be used for the basis for any financial or other transactions associated with the waste processing.

### Control and Management Systems

Referring now to FIG. 12, a waste processing management system 500 is depicted. As shown in FIG. 12, the waste processing management system 500 comprises an integrated control and management system 1201, a system processing management system 1202, which includes a command and control system 1203, a dynamic configuration 1205 in light of a sensor and sensor information set 1204, a machine learning system 1206, a reference information set 1208, a repository 1209 for retaining these information sets, a distributed ledger 1210 to create an immutable record, and a system management 1207 for rendering and managing any of these information sets.

As shown in FIG. 12, the waste processing management system 500 may be in directed communications with any stage of the process, such as waste ingestion 1211, waste processing 1212 and even briquette consumption 1213.

In one embodiment, any of the above elements (e.g., 1201-1210) may be subject to one or more security processes. The one or more security processes may include cryptographic keys for data security and integrity, one or more identity management systems for controlling the access to and/or operation of any one or more of the control functions and one or more process control systems that may control any of the individual or the overall functions the system.

Some specific processing machines, such as trommel, magnetic belt and the like, may have standard industrial control interfaces and/or capability to support an interface as shown in FIG. 12. For example, it may be based on OPC (www.OPCfoundation.org), or other standards such as those specified by ISO, IEEE and other international standards bodies and widely adopted by industry. These interfaces may be integrated with the control and management system 1201 or any other parts of the waste processing management system 500.

As discussed above, each sub-process is monitored by at least one sensor which is configured to capture information related a waste such that the process is optimized for a specific set of outcomes. The outcomes may be specified as an instruction from the control and management system 1201. The instruction may control operations of the process and may in part be determined by a previous and/or subsequent processing.

In one embodiment, inputs and outputs of a specific sub-process may also be used to provide feedback to other processing. For example, configurations of these processes may be in part be determined through the machine learning technique 1206 to those processes, to ensure that outcomes are optimized individually and collectively.

The configurations may be varied dynamically in response to information provided by sensors, specifications and/or analyses undertaken throughout briquette production and consumption.

For example, a specific thermal output may be required on a constant basis. As such, a briquette composition may be configured by the system to provide that specific thermal output. In another example, a thermal output may be required to be higher than its current value. As such, a briquette composition may be adjusted by the system to provide higher thermal outputs.

In one embodiment, such configuration adjustments may be in part determined by composition of an incoming waste, and may involve storage of particular waste types in storage bins for use in briquette composition. For example, if the incoming waste contains a large percentage of PET plastics, as determined by the sensor system at the ingestion stage, part of the incoming waste may be stored as an ingredient for briquettes when either a higher thermal output is required, or another incoming waste has a deficit of PET.

The sensors and sensor information sets can monitor each part and its related process to provide information sets for determining performance and effectiveness of each of the process. These information sets may be directly integrated into the control and management system 1201.

Each of the ingredients that make up the feedstock or briquette are processed in a manner that creates an optimum surface area for the production of the briquettes. Many current other briquette compositions suffer from moisture retention, lack of physical integrity and sub optimal thermal energy outputs. The optimization of the surface area enables the elements that will comprise the briquettes to be have sufficient integrity that the briquette is sufficiently robust for transport and combustion, as well as having the optimum moisture content for the desired thermal output.

Each process that affects the physical dimensions of the elements of waste that are to be combined into the feedstock or briquettes may be configured so as to meet the intended outcomes of the feedstock or briquettes.

Throughout the system, a control and management system may integrate all the control and management systems and the sensor systems as shown in FIG. 1-12 into one single control and management system. Thus, each part of any components of the system can be controlled and managed by the single control and management system.

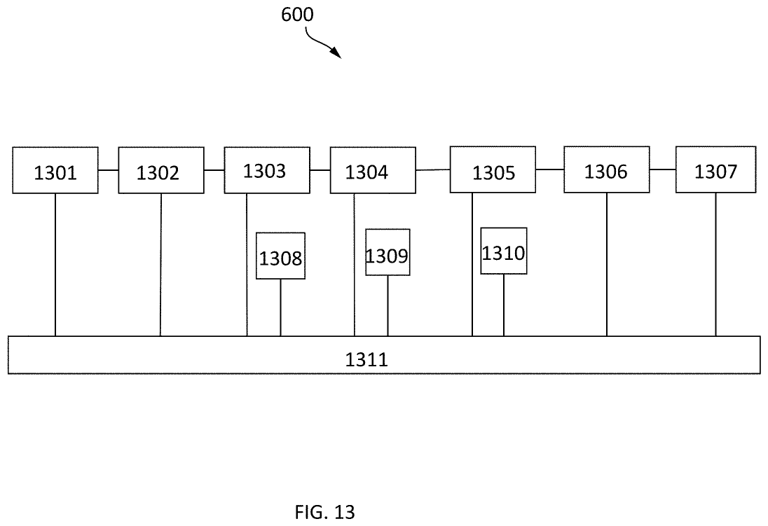

Referring now to FIG. 13, a system 600 comprising one single control and management system comprising the sensor system is depicted.

As shown in FIG. 13, the system 600 comprises one single sensor/control and management system 1311, where a sensor system is integrated into the control and management system.

The system 600 comprises a plurality of sensors located in any part of the system to monitor and control any stage of the process. For example, a sensor 1310 is monitoring and controlling any incoming waste, a sensor 1302 is monitoring and controlling the waste sorting process, a sensor 1303 is monitoring and controlling the shredding process, a sensor 1304 is monitoring and controlling the trammel and its related process, a sensor 1305 is monitoring and controlling the air classifier and its related process, a sensor 1306 is monitoring and controlling the mixing process, and a sensor 1307 is monitoring and controlling the briquette machine and its related process.

Further, a sensor 1308 is monitoring and controlling the magnetic belt and its related process, a sensor 1309 is monitoring and controlling the Eddy current system and its related process, and a sensor 1310 is monitoring and controlling the XRF spectrometer and its related process.

Even further, the system 600 comprises a plurality of sensors to each of the conveyors and any of the receptacles monitoring and controlling the related processes.

### Machine Learning

Machine learning techniques (see, e.g., 1206 of FIG. 12) may be used at any stage of the process. For example, machine learning techniques may be used to establish quantities and potential quality of an incoming material and to evaluate the information sets associated with the materials, configuration of the processing of the materials, combinations of the materials for forming briquettes and even consumption of the briquettes and their output as thermal or energy in any application.

In one embodiment, the machine learning techniques may be used to configure the processing of a waste material to achieve specific inputs or outputs. For example, the machine learning techniques may be used to configure a briquette with a specific thermal output or to configure both a specific briquette and the related processing to achieve a specific emission profile.

Each of the machine learning techniques may be used at any given time, such as during the processing of waste materials, creation of briquettes and any subsequent use of the briquettes in any arrangement.

In some embodiments, such machine learning techniques may form a closed cycle system, which can dynamically vary at least one process, material characteristics, combination of materials to create a specific outcome.

In some embodiments, each sensor in the system can generate information data sets that may be used to train machine learning algorithms. The training may be used to develop a control and management system for the processing of a waste as fuel by optimizing the energy, residues and emissions produced by the process.

Chemical compositions of certain waste materials may be well known. The system with machine learning techniques may use such waste materials as references in a bale of waste. For example, a spectrographic analysis may include the known compositions of these waste materials as filters to reduce complexity of the analysis and support the machine learning techniques through further categorizations.

In one embodiment, the machine learning techniques may be used to evaluate and determine potential thermal outputs, adhesive qualities and water content of various wastes and combinations of wastes. For example, such characteristics may affect production of the briquettes and their subsequent residues and emissions.

These characteristics may be expressed as metrics and applied throughout the whole system to ensure consistency of the briquette compositions and the related characteristics.

The characteristics such as size, volume and quantity of oxygen pockets in the final briquette may be particularly relevant, because they have significant impacts on the burning capability of the final briquette. Although each briquette is made of a common set waste materials, and each material has a common origin, for example PET plastics, each briquette includes different individual component materials.

Thus, the analytics and subsequent configuration of the processing may be designed by using the machine learning techniques to reduce the variations in outcomes to achieve a consistent and reliable thermal result.

Due to a diversity nature of waste materials and a range of contaminants mixed with the waste materials, any signals received by any of the sensors may be treated as a noise. A test corpus of known plastics and paper materials may be created to improve signals.

For example, a large number of bales of wastes can be analyzed, and the output can be used as input to the machine learning techniques to determine a baseline, and specific waste bales with known mixes of wastes can also be created. This baseline may be used to establish a normalized profile to which any noisy data from an incoming waste may be compared.

Similarly, a degree of contamination in a waste may be determined by differentiating compositions of plastics and/or paper/cardboard in the waste. For example, these reference profiles may include paper and cardboard waste with varying degrees of moisture content. Such reference profile sets may be used to categorize, filter and/or organize any incoming information sets from the sensors to support the machine learning system such that the waste processing is not disrupted by the operations and subsequent configurations by the machine learning system.

For example, these reference templates may reduce the number of operations of the machine learning techniques into two groups: one being employed dynamically in the operations and the other generating new reference templates or other configuration sets.

In one embodiment, the first group may often use best fit types of algorithms to identify the anticipated effectiveness of a deployed configuration. The second group may provide inputs to further processing, such as processing other incoming waste materials, to adjust the overall waste materials, such that a specific thermal profile is optimized.

The reference profiles may originally be determined through selection of typical plastics and paper in the condition received as waste. Thus, the original shape may be distorted with multiple bends, creases or tears in the shape. These reference profiles may then be used to match patterns received from sensors and provide data normalization to produce best fit data sets. Machine learning techniques may adopt and use the best fit data sets. As such, the machine learning techniques do not need to evaluate each waste sample to achieve an actionable outcome. Rather, the reference sets may be used to achieve best fit. These reference sets may be expanded to create a pattern that can be applied in the shortest possible time, such that rate of waste processing is not limited by the time required to achieve an evaluation of the waste. The evaluation may be sufficiently accurate to match the specifications of the briquettes required and of sufficient granularity to configure the related parts of the system.

In one embodiment, the system comprising the machine learning techniques may recognize creases in plastic materials. For example, signals of the creases in images captured by sensors may be significantly higher than the background, thus providing a higher signal to noise ratio for the creases. Further, as the creases may have distended the shape of plastics, each of the types of plastics may have different crease characteristics, such as the peak ridge of the crease and the surrounding surface.

In some embodiments, the creases in the plastic waste may be measured by using slip line theory, Eulerian strain tensors or any other techniques. Any combination of these techniques may provide an effective measurement of relative quantities of each type of plastic in a waste bale.

As the chemical composition of each type of plastic material varies, signals of the corresponding creases in the materials may change. Other feature sets of these images may also be integrated into reference profiles, providing an efficient method for evaluating the content of bales of waste in a timely manner.

In one embodiment, the system comprising the machine learning techniques may recognize reflectivity of cardboard, particularly with various degrees of moisture. The surface of the cardboard is likely to be distended, and will thus absorb more light than plastic, glass, metal or other materials of high reflectivity.

In some embodiments, a ratio of reflectivity of the materials to the absorption of the same materials may be measured at each stage of the process to identify the likely composition of any incoming waste.

The reference profiles may further include feature sets, which can be used to identify features in images or other sensor data of any incoming waste. The underlying feature sets of the waste materials (e.g., plastics) may include smoothness, linearity, manifolds, natural clustering, sparsity, dependencies, all of which may be used to regularize the data sets generated by the sensors.

In one embodiment, the system comprising the machine learning techniques may integrate multiple sensor inputs from different sensors over a given time period.

### Blockchain/Distributed Ledger Integration

In one embodiment, the system of the present disclosure may also include techniques of blockchain and/or distributed ledger integration.

As the recycling industry moves to closer coupling with the production of the materials that create the waste, a trusted reference of the characteristics of the waste materials becomes ever more important. The ability for a waste processor to evaluate the incoming waste and to create profiles as to the utility of that waste in further recycling processing (such as the production of energy from materials with sufficient energy potential) becomes an important step in the overall lifecycle of such products.

The information captured during the processing and the end use (e.g., burned for energy) of waste products may inform producers of those products as to the potential variations in the product composition. For example, any addition or removal at production stage of certain elements may enhance the energy released, reduce the residue after burn, impact the emissions or in other ways enhance the recycling process.

Such information may have a number of consequences, such financial and/or environmental ones. For example, the price for the waste processing may be included in the product initial cost, or carbon credits or other environmental impact credits or debits may be accrued by the original producers, packagers or other value chain participants.

In one embodiment, the capture and immutable storage of the receipt, processing and use of the waste may be achieved by using a distributed ledger (see FIGS. 11 and 12), which establishes the record of these undertakings.

In some embodiments, distributed ledgers may be used to substantiate in an immutable manner the composition of the waste is received, the processes that are undertaken to create briquettes and any other waste processing associated with preparation of the briquettes, the composition and thermal or other characteristics of the briquettes, their transport and ingestion into systems for their combustion and subsequent combustion, emissions, residue and energy output.

In this manner, the complete lifecycle of the waste from reception by the system to energy output may be recorded in an immutable repository. The immutable repository may form the basis of a system with financial or other value related consequences for the providers of the waste, the users of the energy, the creators of the initial products or any other stakeholder in the value chain.

Distributed ledgers and repositories may be used to create immutable audit trails, which include sources of waste compositions. The information may be used to inform a range of other systems, such as financial systems, waste quality analytics, plastic and other material compositions and characteristics when used as fuel in waste, material composition of those materials at manufacture, treatment and transport of those waste materials and the like.

Briquette composition may be recorded in the distributed ledger and each briquette may carry a form of indicia, which can be confirmed at the point of production of such a briquette. As such, briquettes transported from a waste processing facility may include information sets (such as database) available to a user of such briquettes. The information sets may describe thermal characteristics, composition, source and other information related to the specific briquettes.

In some embodiments, such distributed ledgers may provide proof of burn and energy production from specific wastes, which can have financial or other consequences (e.g., carbon credits or other environmental consequences).

In some embodiments, briquettes may be aggregated into larger quantities, for example using bulker bags, which may be assigned a blockchain identifier, providing an immutable audit trail for those briquettes. Such an identifier may also contains details on emission expected as a result of input stocks and thermal capability, such as carbon emission and dust.

Such an identifier may be particularly important when the related briquettes have some form of associated consequences, such as financial, environmental and the like. Such an identifier may also provide an immutable reference to the source, processing, composition and any associated assay information of the briquettes.

Thus, the system of the present disclosure may provide the support for economic impacts both upstream and downstream of briquette production and use, e.g., based on an immutable audit trail and proof of event, by using the sensors and configurations described herein and immutably recorded in at least one distributed ledger.

The system of the present disclosure may ensure any end client or user of the briquettes now or anytime in the future with detail information on the thermal capability and input stock used in their end point system. The end client or user may also calculate in hindsight the carbon emissions in a full end to end equation.

### Example Briquettes and the Briquette Formation

Methods and systems of the present disclosure can be used to produce briquettes with consistent and controllable thermal property. As shown in FIG. 8 and FIG. 9, the mixture pieces with a controllable ratio of plastic-based material to cellulose-based material may be heated and compressed through a briquette machine to form briquettes.

Once the mixture pieces are shredded to the pre-set sizes, the mixture pieces are then processed through a briquette machine so that, when an appropriate pressure is applied, a briquette without any binding agent forms. Lack of binding agents in the briquettes may improve the optimal thermal characteristics of the briquettes and lower the overall costs of the briquettes.

In one embodiment, the average sizes of the mixture pieces may range from 225 mm² to 25 mm², depending on the waste materials and the proportions of waste materials combined to form a briquette.

Plastic has a tendency to hold its original shape. As such, plastic-based materials require greater pressure to form briquettes than paper. Paper or other cellulose based material is a critical adjunct to the formation of a briquette, as plastic alone may be more difficult to form a briquette without applying a maximum heat. For example, heat up to 30 degrees centigrade for a compression and/or hold up to 10 seconds for a briquette containing plastics may, in some cases, be the maximum heat and time to form briquettes. Table 2 (described previously) shows pressure (in pascals) required for different briquette compositions.

Two inputs for the briquette composition are cellulose-based materials, particularly paper and cardboard, and various petroleum waste products, which are mostly plastics. Paper may be mostly made from organic compounds, which include carbon, hydrogen and oxygen (C, H & O). Paper may also contain non-organic materials included during manufacture. The non-organic materials, including chalk (CaCO₃) and kaolin clay (Al₂Si₂O₅(OH)₄) in small amounts, were used to improve its properties.

The mixture of waste components may be used to vary the thermal ranges desired from the briquettes. Some of the examples are illustrated in Table 3.

TABLE 3
Indicative thermal characteristics

| | Thermal | | Predominant | Petra |
|---|---|---|---|---|
| | range in | Predominant | PET | product |
| | kcal/kg | paper | plastic | name |
| 1 | 3,000-4,000 | 80% | 20% | Brown |
| | | input | input | Petra |
| 2 | 4,000-5,500 | 50% | 50% | Black |
| | | input | input | Petra |
| 3 | 5,500-7,500 | 20%-30% | 70%-80% | Coking |
| | | input | input | Petra |

Methods and systems of the present disclosure may be used to produce the feedstock or briquettes with sufficient reliability and consistency in a specified thermal range and in a controllable manner. Further, thermal property of the feedstock or briquettes may be controllable, e.g., by changing a ratio of the cellulose-based stockpile to the plastic-based stockpile along with other parameters in the system.

In one embodiment, the resulting feedstock or briquettes of the present disclosure with controllable compositions as discussed above may have known emission properties. For example, through use of an infrared fluorescent technology, the content of the resulting feedstock or briquettes can be known and also from their emissions. As such, the feedstock or briquettes can have a clear predictable view on what scrubbers best serve further minimization of emissions encoded in their accompanying blockchain detail.

It should be noted that most end use burn of the feedstock or briquette systems would have systems for limiting emissions, which in some embodiments will include sensor systems, for the monitoring and evaluation of the emissions. The information sets from these sensor systems may be used within the dynamic control and management of the waste processing. In some embodiments, the information generated may be stored in a distributed ledger, where for example such information may be used to ascertain, in whole or in part financial or other value related consequences.

Table 4 shows a weight to thermal energy comparison between the briquettes and raw waste. When comparing the weight of waste to the briquettes to produce 1 MW of energy, Table 4 shows that the briquette (50/50) require 6.25 less weight to produce the same MW outcome. Thus, it requires 6.25 times more raw waste to produce 1 MW than the briquette (50/50).

TABLE 4
Weight to thermal energy comparison

| | | briquettes |
|---|---|---|
| | WtE | (50/50) |
| Thermal power - kcal/kg | 748 | 4,680 |
| Weight in tons | 1.82 | 0.29 |
| Elec - 1 MW | 1 | 1 |
| WtE comparison | | 6.25 |

### Example Waste Handling and Thermal Product Production Processes

In one aspect, the present disclosure relates to a method for dynamically processing waste and/or for producing thermal products such as feedstock (e.g., fluff type form of feedstock) or briquettes with controllable thermal properties. An example method may utilize the system or part of the system as disclosed above for dynamically processing waste and/or for producing thermal products such as feedstock or briquettes with controllable thermal properties. Briquettes or feedstock with consistent and designable thermal property.

In one embodiment, the method and the related system disclosed herein may process a municipal waste (also referred to as MSW), commercial and industrial waste (also referred to as C&I waste) and construction and demolition waste (also referred to as C&D waste) into the at least one recycle product and the thermal product. The source of the waste may be aligned with the production of the thermal product with specified characteristics. For example, if an industrial process involving materials with appropriate thermal characteristics, such as wood working, plastics production, cardboard production and the like, creates a waste product that is well suited to the method for producing thermal products from that waste, such waste may be collected independently of municipal waste and treated with processing that is better suited to that waste type.

In one embodiment, the method comprises: producing from a municipal waste (or a C&I waste or C&D waste) a cellulose-based material stockpile and a plastic-based material stockpile; automatically measuring at least one physical property of the cellulose-based material stockpile and at least one physical property of the plastic-based material stockpile; based on the measurements of the at least one physical property the cellulose-based material stockpile and the measurements of the at least one physical property of the plastic-based material stockpile, automatically controlling mixing the cellulose-based material stockpile and the plastic-based material stockpile to form a mixture by adjusting a ratio of the cellulose-based material stockpile to the plastic-based material stockpile; and automatically heating and compressing the mixture to form the thermal product.

In one embodiment, the at least one physical property may comprise one or more of density, purity, wetness and average sizes of the cellulose-based material pieces or the paper-based material pieces. In one embodiment, the at least one physical property comprises one or more of density, purity, weight, thermal capability (measured in kcal/kg), combustion efficiency, direct and ambient heat at varying pressure levels (similar to pressure levels in end use kilns), wetness and average sizes of the cellulose-based material pieces or the paper-based material pieces.

In one embodiment, the method further comprises utilizing a machine learning model to heuristically optimize the thermal property of the thermal product.

In one embodiment, the present disclosure relates to a method for isolating at least one recycle product from a municipal waste (or a C&I waste or C&D waste) and producing a thermal product from the municipal waste.

In one embodiment, the method comprises pre-sorting the municipal waste into at least a first waste comprising a majority of plastic-based material and a second waste comprising a majority of at least one cellulose-based material selected from the group consisting of paper, cardboard, wood, textile and carpet.

In one embodiment, the method further comprises separating the at least one recycle product from the first waste and producing a first stockpile from the first waste, which specifically comprises: shredding, by using a first shredder comprising a magnetic belt, the first waste and separating ferrous-based recycle products from the first waste either before or after the shredding to form a first intermediate waste; sieving, by using a first screening or sieving device, the first intermediate waste to separate sand and/or soil-based recycle products to form a second intermediate waste; separating, by using a first air classifier, heavy recycle products from the second intermediate waste to form a third intermediate waste; and extracting, by using a first eddy current system, non-ferrous metals such as aluminum from the third intermediate waste to form the first stockpile.

In one embodiment, the method further comprises separating the at least one recycle product from the second waste and producing a second stockpile to form the second waste, which specifically comprises shredding, by using a second shredder comprising a magnetic belt, the second waste and separating ferrous-based recycle products from the second waste either before or after the shredding to form a fourth intermediate waste; sieving, by using a second screening or sieving device comprising a heating device, the fourth intermediate waste to separate sand and/or soil-based recycle products to form a fifth intermediate waste; separating, by using a second air classifier, heavy recycle products from the fifth intermediate waste to form a sixth intermediate waste; and extracting, by using a second eddy current system, non-ferrous metals such as aluminum from the sixth intermediate waste to form the second stockpile.

In one embodiment, the method further comprises processing the first stockpile and the second stockpile to produce the thermal product, which specifically comprises: controlled mixing, by using a mixer, the first stockpile and the second stockpile proportionally to form a first mixture; shredding, by using a hammer mill (or a shredder that can shred the stockpiles into a sufficiently small size e.g., about 1 cm in diameter), the first mixture into pieces with a pre-determined size to form a second mixture; measuring, by using an X-ray Fluorescence (XRF) system, at least one physical property of the second mixture, identifying and removing additional recycle products to form a third mixture; and heating and compressing, by using a thermal-product-forming machine, the third mixture to form the thermal product.

In one embodiment, the first stockpile is a cellulose-based material stockpile and the second stockpile is a plastic-based material stockpile.

In one embodiment, the method comprises automatically controlled mixing the cellulose-based material stockpile and the plastic-based material stockpile to form a mixture by adjusting a ratio of the cellulose-based material stockpile to the plastic-based material stockpile on the basis of the measurement of the at least one physical property.

In one embodiment, the method further comprises utilizing a machine learning model to heuristically optimize thermal property of the thermal product.

In one embodiment, the at least one physical property further comprises one or more of density, purity, wetness and average sizes of the cellulose-based material pieces or the plastic-based material pieces. In one embodiment, the at least one physical property comprises one or more of density, purity, weight, thermal capability (measured in kcal/kg), combustion efficiency, direct and ambient heat at varying pressure levels (similar to pressure levels in end use kilns), wetness and average sizes of the cellulose-based material pieces or the paper-based material pieces.

In one embodiment, the at least one recycle product comprise at least one material selected from the group consisting of glass, aluminum, soil, sand, rock, brick, ferrous metal, non-ferrous metal and non-aluminum metal.

In one embodiment, the method further comprises controlling a mixture ratio of the first stockpile to the second stockpile to produce the thermal product with a consistent and designable thermal property.

In one embodiment, the method further comprises controlling a mixture ratio of the first stockpile to the second stockpile to produce the thermal product with a thermal property in the range of about 1,000 kcal/kg to about 10,000 kcal/kg.

In one embodiment, the method further comprises controlling a mixture ratio of the first stockpile to the second stockpile to produce the thermal product with a thermal property in the range of about 2,000 kcal/kg to about 9,000 kcal/kg.

In one embodiment, the method further comprises controlling a mixture ratio of the first stockpile to the second stockpile to produce the thermal product with a thermal property in the range of about 3,000 kcal/kg to about 8,000 kcal/kg.

In one embodiment, the thermal product is a briquette.

In some embodiments, the briquette is selected from the group consisting of a brown Petra with a thermal property of about 3,000 kcal/kg to about 4,000 kcal/kg, a black Petra with a thermal property of about 4,000 kcal/kg to about 5,500 kcal/kg, and a coking Petra with a thermal property of about 5,500 kcal/kg to about 7,500 kcal/kg.

In one embodiment, the thermal product is a feedstock (e.g., fluffy feedstock), with thermal properties that can be configured to range from 3000 kcal/kg to 7,500 kcal/kg.

In one embodiment, during the pre-sorting step, bulk concrete and other low-thermal-property materials are removed from the municipal waste.

In one embodiment, during the first separating step (i.e., for producing a first stockpile), steels or other magnetic metals are removed from the first waste.

In one embodiment, the plastic-based material in the first intermediate waste is shredded into plastic pieces about 40 mm to about 60 mm in diameter.

In one embodiment, the plastic-based material in the first intermediate waste is shredded into plastic pieces about 60 mm in diameter.

In one embodiment, during the first separating step (i.e., for producing a first stockpile), sand and/or soil are removed from the first intermediate waste and are collected as the at least one recycle product.

In one embodiment, during the first separating step (i.e., for producing a first stockpile), heavy materials such as rocks, bricks and heavy metals are removed from the second intermediate waste and are collected as the at least one recycle product.

In one embodiment, during the first separating step (i.e., for producing a first stockpile), non-ferrous metals such as aluminum are removed from the third intermediate waste and are collected as the at least one recycle product.

In one embodiment, during the second separating step (i.e., for producing a second stockpile), steels or other metals with magnetic properties are removed from the second waste.

In one embodiment, the at least one cellulose-based material in the fourth intermediate waste is shredded into cellulose-based material pieces about 40 mm to about 60 mm in diameter.

In one embodiment, the at least one cellulose-based material in the fourth intermediate waste is shredded into cellulose-based material pieces about 60 mm in diameter.

In one embodiment, during the second separating step (i.e., for producing a second stockpile), sand and/or soil are removed from the fourth intermediate waste and are collected as the at least one recycle product.

In one embodiment, during the second separating step (i.e., for producing a second stockpile), heavy materials such as rocks, bricks and heavy metals are removed from the fifth intermediate waste and are collected as the at least one recycle product.

In one embodiment, during the second separating step (i.e., for producing a second stockpile), non-ferrous metals such as aluminum are removed from the sixth intermediate waste and are collected as the at least one recycle product.

In one embodiment, during the processing step (i.e., to produce the thermal product), the ratio of the first stockpile to the second stockpile is in the range of 1:100 to 100:1.

In one embodiment, during the processing step (i.e., to produce the thermal product), the ratio of the first stockpile to the second stockpile is in the range of 1:50 to 50:1.

In one embodiment, during the processing step (i.e., to produce the thermal product), the ratio of the first stockpile to the second stockpile is in the range of 1:10 to 10:1.

In one embodiment, during the processing step (i.e., to produce the thermal product), the plastic pieces and the cellulose-based material pieces are further shredded into mixture pieces about 1 mm to about 10 mm in diameter or about 5 mm to about 10 mm in diameter. The size of these pieces is determined, in part by the final outcome, either as feedstock or briquettes, and the intended application of both, in terms of thermal characteristics.

In one embodiment, during the processing step (i.e., to produce the thermal product), the method further comprises identifying, by using XRF system, additional recycle products; and removing the additional recycle products from the second mixture and collecting them as the at least one recycle product.

In one embodiment, during the processing step (i.e., to produce the thermal product), the method further comprises identifying, by using XRF system, contaminants such as PVC; and removing the contaminants from the second mixture.

In one embodiment, during the processing step (i.e., to produce the thermal product), the method further comprises controlling the thermal property of the thermal product by varying a ratio of the first stockpile to the second stockpile.

In one embodiment, the method is automatically controlled through a controller.

In one embodiment, the XRF may be the primary means of assessing thermal capability of the shredded waste, its moisture and whether or not the remaining molecules will result in the desired minimization of environmental emissions. The XRF may be the primary means of sourcing such information to feed into the data pool used to make heuristic decisions to control the end to end process via the controller.

In one embodiment, the method further comprises a step of quality control, wherein a controller takes inputs from the XRF system and wherein if necessary, the controller sends instructions to related machines to take steps to increase quality of the thermal product.

In one aspect, the present disclosure relates to a system having a plurality of components capable of performing the above method for processing a municipal waste into the at least one recycle product and the thermal product.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for isolating at least one recycle product from a municipal waste and producing a thermal product from the municipal waste, the method comprising:
a. pre-sorting the municipal waste into at least a first waste comprising a majority of plastic-based material and a second waste comprising a majority of cellulose based material, the cellulose based material including at least one cellulose-based material selected from the group consisting of paper, cardboard, wood, textile and carpet;
b. separating the at least one recycle product from the first waste and producing a first stockpile from the first waste, comprising
i. shredding, by using a first shredder, the first waste and separating ferrous-based recycle products from the first waste either before or after the shredding using a magnetic belt to form a first intermediate waste;
ii. processing, by using a first screening or sieving device, the first intermediate waste to separate sand and/or soil-based recycle products to form a second intermediate waste;
iii. separating, by using a first air classifier, heavy recycle products from the second intermediate waste to form a third intermediate waste; and
iv. extracting, by using a first eddy current system, non-ferrous metals such as aluminum from the third intermediate waste to form the first stockpile;
c. separating the at least one recycle product from the second waste and producing a second stockpile to form the second waste, comprising
i. shredding, by using a second shredder the second waste and separating ferrous-based recycle products from the second waste using a magnetic belt either before or after the shredding to form a fourth intermediate waste;
ii. processing, by using a second screening or sieving device comprising a heating device, the fourth intermediate waste to separate sand and/or soil-based recycle products to form a fifth intermediate waste;
iii. separating, by using a second air classifier, heavy recycle products from the fifth intermediate waste to form a sixth intermediate waste; and
iv. extracting, by using a second eddy current system, non-ferrous metals such as aluminum from the sixth intermediate waste to form the second stockpile;
d. processing the first stockpile and the second stockpile to produce the thermal product, comprising:
i. controlled mixing, by using a mixer, the first stockpile and the second stockpile proportionally to form a first mixture;
ii. shredding, by using a hammer mill, the first mixture into pieces with a pre-determined size to form a second mixture; and
iii. measuring, by using an X-ray Fluorescence (XRF) system, at least one physical property of the second mixture, identifying and removing additional recycle products to form a third mixture.

2. The method of claim 1, wherein the method comprises automatically controlled mixing the cellulose-based material stockpile and the plastic-based material stockpile to form a mixture by adjusting a ratio of the cellulose-based material stockpile to the plastic-based material stockpile based on the measurement of the at least one physical property.

3. A method for producing a thermal product with a consistent and predetermined thermal property, the method comprising:
a. producing from a mixed waste a cellulose-based material stockpile and a plastic-based material stockpile;
b. automatically measuring at least one physical property of the cellulose-based material stockpile and at least one physical property of the plastic-based material stockpile; and
c. based on the measurements of the at least one physical property the cellulose-based material stockpile and the measurements of the at least one physical property of the plastic-based material stockpile, automatically controlling mixing the cellulose-based material stockpile and the plastic-based material stockpile to form a mixture by adjusting a ratio of the cellulose-based material stockpile to the plastic-based material stockpile to produce a thermal product with a predetermined thermal property.

4. The method of claim 3, wherein the thermal product is a briquette, the method further comprising:
automatically compressing the mixture to form the briquette.

5. The method of claim 3, wherein the at least one physical property comprises one or more of density, purity, wetness and average sizes of the cellulose-based material pieces.

6. The method of claim 3, wherein the method further comprises utilizing a machine learning model to control the thermal property of the thermal product.

7. The method of claim 6, wherein the first stockpile is a cellulose-based material stockpile and the second stockpile is a plastic-based material stockpile

8. (canceled)

9. (canceled)

10. (canceled)

11. The method of claim 6, wherein the method further comprises controlling a mixture ratio of the first stockpile to the second stockpile to produce the thermal product with a thermal property in the range of about 1,000 kcal/kg to about 10,000 kcal/kg.

12. (canceled)

13. (canceled)

14. (canceled)

15. The method of claim 3, wherein the thermal product is a briquette selected from the group consisting of a brown Petra with a thermal property of about 3,000 kcal/kg to about 4,000 kcal/kg, a black Petra with a thermal property of about 4,000 kcal/kg to about 5,500 kcal/kg, and a coking Petra with a thermal property of about 5,500 kcal/kg to about 7,500 kcal/kg.

16. (canceled)

17. (canceled)

18. The method of claim 6, wherein the plastic-based material in the first intermediate waste is shredded into plastic pieces about 40 mm to about 60 mm in diameter.

19. (canceled)

20. (canceled)

21. (canceled)

22. (canceled)

23. (canceled)

24. The method of claim 6, wherein the at least one cellulose-based material in the fourth intermediate waste is shredded into cellulose-based material pieces about 40 mm to about 60 mm in diameter.

25. (canceled)

26. (canceled)

27. (canceled)

28. (canceled)

29. (canceled)

30. (canceled)

31. The method of claim 6, wherein during the step (d)(i), the ratio of the first stockpile to the second stockpile is in the range of 1:10 to 10:1.

32. The method of claim 6, wherein during the step (d)(ii), the plastic pieces and the cellulose-based material pieces are further shredded into mixture pieces about 5 mm to about 10 mm in diameter.

33. The method of claim 6, further comprising:
during the step (d)(ii), identifying, by using XRF system, additional recycle products;
and removing the additional recycle products from the second mixture and collecting them as the at least one recycle product.

34. (canceled)

35. The method of claim 6, further comprising:
during the step (d), controlling the thermal property of the thermal product by varying a ratio of the first stockpile to the second stockpile.

36. (canceled)

37. (canceled)

38. (canceled)

39. The method of claim 3, wherein the method further comprises:
automatically heating and compressing the mixture to form the thermal product.

40. (canceled)

41. A system for processing a municipal waste into at least one recycle product and a thermal product, the system comprising:
a pre-sorting component comprising at least one loader and a plurality of receptacles;
a waste-processing component comprising
a shredder further comprising a magnetic belt,
a screening or sieving device mechanically connected with the shredder so that an end product from the shredder automatically forms an input material of the screening or sieving device,
an air classifier mechanically connected with the screening or sieving device so that an end product from the screening or sieving device automatically forms an input material of the air classifier, and
an eddy current system mechanically connected with the air classifier so that an end product from the air classifier automatically forms an input material of the eddy current system;
a thermal-product forming component comprising
a mixer,
a mill mechanically connected with the mixer so that an end product from the mixer automatically forms an input material of the mill,
an XRF system mechanically connected with the mill so that an end product from the mill automatically forms an input material of the XRF system, and
a thermal-product-forming machine mechanically connected with the XRF system so that an end product from the XRF system automatically forms an input material of the thermal-product-forming machine; and
a controller in communication with and configured to control the pre-sorting component, the waste-processing component, and the thermal-product forming component.

42. The system of claim 41, wherein the controller takes measurement inputs from the XRF system and wherein the controller is configured to instruct the mixer to controlled mix a cellulose-based material stockpile and a plastic-based material stockpile to form a mixture by adjusting a ratio of the cellulose-based material stockpile to the plastic-based material stockpile on the basis of the measurement inputs of at least one physical property from the XRF system.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. The system of claim 41, wherein the mill is a hammer mill is configured to shred plastic pieces and/or cellulose-based material pieces into mixture pieces about 5 mm to about 10 mm in diameter.

61. The system of claim 41, wherein the XRF system is configured to identify additional recycle products from mixture pieces, which are removed and collected as the recycle product.

62. (canceled)

63. (canceled)

64. (canceled)

65. The system of claim 41, wherein the system is configured to produce the thermal product with a predetermined thermal property by varying a ratio of a plastic-based material stockpile to a cellulose-based material stockpile.

66. (canceled)

67. (canceled)

68. (canceled)

69. (canceled)

70. (canceled)

71. (canceled)
